(19) United States
(12) Patent Application Publication
(10) Pub. No.: US 2016/0376451 A1
(43) Pub. Date: Dec. 29, 2016

(54) PHOTOCURABLE INKJET INK

(71) Applicant: JNC CORPORATION, Tokyo (JP)

(72) Inventors: Kohei ONO, ICHIHARA-SHI, CHIBA (JP); Katsuyuki SUGIHARA, ICHIHARA-SHI, CHIBA (JP); Takayuki HIROTA, ICHIHARA-SHI, CHIBA (JP)

(73) Assignee: JNC CORPORATION, TOKYO (JP)

(21) Appl. No.: 15/039,850

(22) PCT Filed: Nov. 26, 2014
(86) PCT No.: PCT/JP2014/081212

§ 371 Date: May 26, 2016

(30) Foreign Application Priority Data
Nov. 28, 2013 (JP) 2013-246163

(51) Int. Cl. C09D 11/101; G02B 1/18; G02B 3/00; C09D 11/38; C08F 220/28

(52) U.S. Cl. CPC C09D 11/101; C09D 11/38; C08F 220/28; G02B 3/00; G02B 1/18; C08F 2220/285

(57) ABSTRACT

Shown are: a photocurable inkjet ink containing 3 to 60 wt % of a compound (A1) represented by either of the following formulae (15) and (16), and 0.1 to 1 wt % of a surfactant (F); a liquid-repellent cured film obtained by photocuring the photocurable inkjet ink; a laminate which has the liquid-repellent cured film formed on a substrate having a refractive index of 1.55 or more with respect to light of a wavelength of 589 nm; a laminate which has the liquid-repellent cured film formed on a substrate having a refractive index of 1.55 or more with respect to light of a wavelength of 589 nm, and also has a microlens formed on the liquid-repellent cured film; an optical component which has a laminate having the microlens; and an image display device which has the optical component.

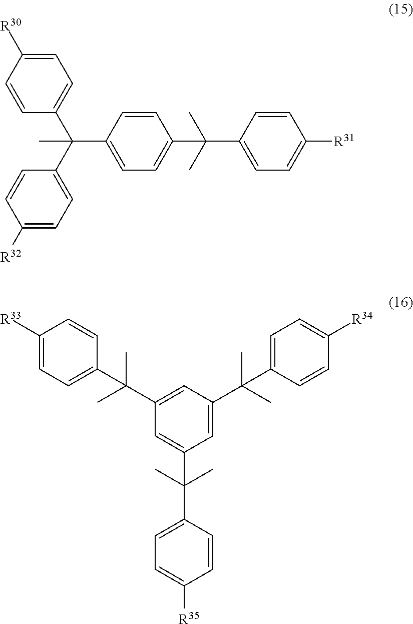

### FIELD OF THE INVENTION

The invention relates to a photocurable inkjet ink suitably used for manufacturing a light guide as a member of a backlight unit built in an optical instrument such as an image display device, etc. More specifically, the invention relates to a photocurable inkjet ink, the photocurable inkjet ink being employed in a microlens that is employed in manufacturing a light guide and also being employed in a liquid-repellent cured film used for controlling a shape of the microlens.

### DESCRIPTION OF THE RELATED ART

Conventionally, a microlens formed on a light guide for an image display device has been formed by injection molding using a mold. However, when manufacturing various kinds of microlenses in small quantities using this method, it is necessary to remake the mold according to product designs, and an increase in manufacturing steps has become a problem.

In recent years, as a manufacturing method having high design freedom, a method has been proposed of using an inkjet method to directly form a microlens on a substrate surface (e.g., see Patent Documents 1 and 2).

In such a microlens manufacturing method using an inkjet method, a microlens pattern to be printed can be easily modified by means of a computer or the like. Therefore, even for production of various kinds in small quantities, the number of manufacturing steps does not change and manufacturing cost can be reduced. In view of this, the manufacturing method is expected.

As a substrate employed in the light guide, an acrylic resin-based substrate (hereinafter “PMMA substrate”) has conventionally been employed. However, from the viewpoint of weight reduction, moisture resistance and heat resistance of the substrate, recently, development has been underway of a light guide using a polycarbonate resin-based substrate (hereinafter “PC substrate”), a polystyrene resin-based substrate (hereinafter “PS substrate”) and an acryl-styrene copolymer polymer substrate (hereinafter “MS substrate”), etc., all having a higher refractive index than the PMMA substrate.

In the light guide, in order to well extract light, the refractive indexes of all the microlens, a liquid-repellent cured film that controls a shape of the microlens, and the substrate are expected to be substantially the same. The reason is that, if the refractive index of the liquid-repellent cured film is lower than the refractive index of the substrate, a refractive index difference occurs at an interface between the substrate and the liquid-repellent cured film, and light having a small incidence angle is more likely to be totally reflected, thus causing a problem that light extraction efficiency is reduced. The same holds true for the relationship between the refractive index of the liquid-repellent cured film and the refractive index of the microlens. Accordingly, to solve these problems, it is necessary to form a microlens and a liquid-repellent cured film that have substantially the same refractive index as the substrate.

Furthermore, for the microlens and the liquid-repellent cured film that controls the shape of the microlens, a cured product reduced in yellowness as much as possible and high in light transmittance is desired. The reason is that, when the cured product has high yellowness, there is a risk that the light guide may appear yellowish so that high image quality cannot be achieved any longer, and that high light transmittance is required for achieving higher light extraction efficiency.

When an inkjet ink that has been employed in the PMMA substrate is used in the PC substrate, the PS substrate and the MS substrate that have a high refractive index, the light extraction efficiency is reduced. Therefore, an inkjet ink that allows a cured product having a higher refractive index to be obtained is desired.

As a composition having a high refractive index, there are known a composition using a monomer that has a fluorene skeleton in a molecule (e.g., see Patent Documents 3 to 5), a composition using a monomer that has a phosphine oxide in a molecule (e.g., see Patent Document 6), and a composition using a monomer that has a bisphenol A skeleton in a molecule (e.g., see Patent Documents 7 to 8).

However, even though these compositions can be discharged by inkjet, they have a problem that the composition that forms a cured product having a high refractive index has strong yellowness, and the composition that forms a cured product having low yellowness has a low refractive index.

### PRIOR-ART DOCUMENTS

### Patent Documents

Patent Document 1: JP 2000-180605
Patent Document 2: JP 2004-240294
Patent Document 3: JP H6-220131
Patent Document 4: JP 3797223
Patent Document 5: JP 2008-081572
Patent Document 6: WO 2010-004959
Patent Document 7: JP 03547307
Patent Document 8: JP 2012-242464

### SUMMARY OF THE INVENTION

### Problems to be Solved

Under such conditions, an inkjet ink having excellent photocurability and a high refractive index as well as allowing a photocured product that has reduced yellowness to be obtained is desired.

### Means for Solving the Problems

As a result of earnest studies, the inventors were successful in developing an inkjet ink having excellent photocurability and a high refractive index as well as allowing a photocured product that has low yellowness to be obtained, by using an acrylate having a specific structure.

The invention includes the following items.
Item [1] is a photocurable inkjet ink, containing 3 to 60 wt % of a compound (A1) represented by either of the following formulae (15) and (16) and 0.1 to 1 wt % of a surfactant (F).

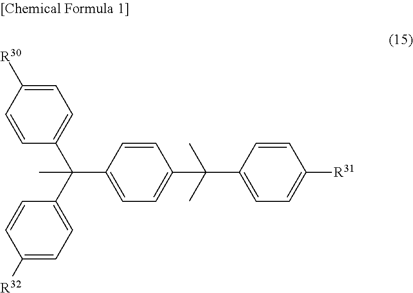

(At least one of R³⁰, R³¹ and R³² is a group selected from the following organic groups d, and the rest are a hydroxyl group or an alkyl group having 1 to 5 carbons.)

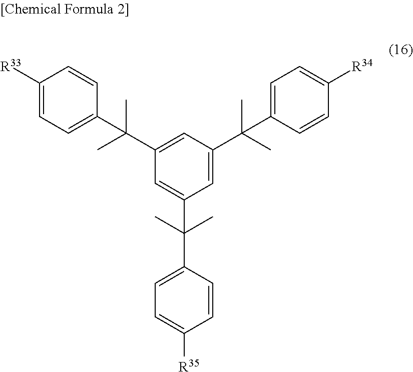

(At least one of R³³, R³⁴ and R³⁵ is a group selected from the following organic groups d, and the rest are a hydroxyl group or an alkyl group having 1 to 5 carbons.)
   [Organic Groups d]

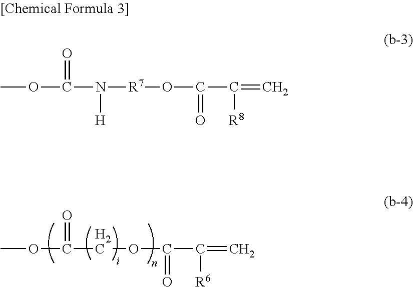

(R⁷ is independently a divalent hydrocarbon group having 1 to 10 carbons; R⁶ and R⁸ are independently hydrogen or a methyl group; i is an integer of 1 to 5; and n is an integer of 0 to 5.)
Item [2] is the photocurable inkjet ink described in [1], wherein the compound (A1) is a compound represented by either of the following formulae (5) and (6).

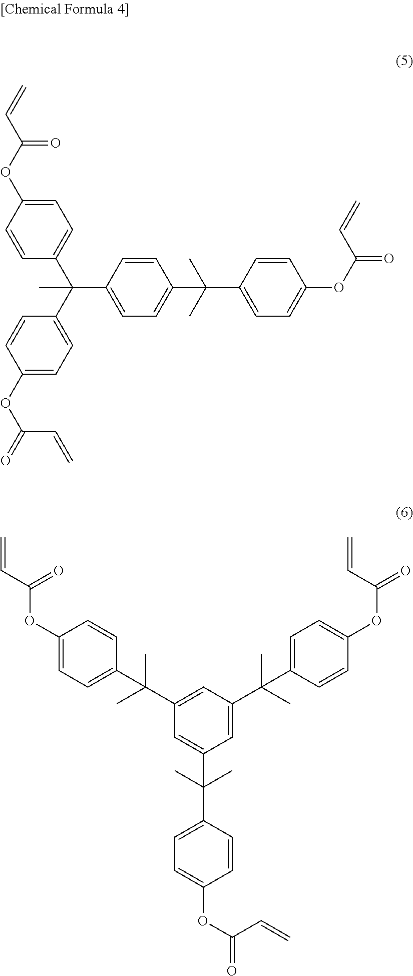 [SMILES: C=CC(=O)Oc1ccc(C(C)(C)c2ccc(C(C)(c3ccc(OC(=O)C=C)cc3)c3ccc(OC(=O)C=C)cc3)cc2)cc1 ; C=CC(=O)Oc1ccc(C(C)(C)c2cc(C(C)(C)c3ccc(OC(=O)C=C)cc3)cc(C(C)(C)c3ccc(OC(=O)C=C)cc3)c2)cc1]

Item [3] is the photocurable inkjet ink described in [1], wherein the compound (A1) is a compound represented by the following formula (5).

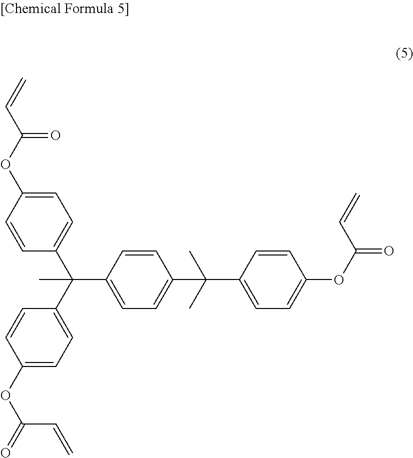 [SMILES: C=CC(=O)Oc1ccc(C(C)(C)c2ccc(C(C)(c3ccc(OC(=O)C=C)cc3)c3ccc(OC(=O)C=C)cc3)cc2)cc1]

Item [4] is the photocurable inkjet ink described in any one of [1] to [3], further containing a photopolymerization initiator (C).
Item [5] is the photocurable inkjet ink described in any one of [1] to [4], further containing a solvent (D), or a (meth)acrylate monomer (G) other than the compound (A1).
Item [6] is a liquid-repellent cured film obtained by photocuring the photocurable inkjet ink described in any one of [1] to [5].
Item [7] is a laminate having a substrate that has a refractive index of 1.55 or more with respect to light of a wavelength of 589 nm, and the liquid-repellent cured film described in [6] formed on the substrate.
Item [8] is a laminate having a substrate that has a refractive index of 1.55 or more with respect to light of a wavelength of 589 nm, the liquid-repellent cured film described in [6] formed on the substrate, and a microlens formed on the liquid-repellent cured film.
Item [9] is an optical component having the laminate described in [8].
Item [10] is an image display device including the optical component described in [9].

### Effects of the Invention

The inkjet ink of the invention has excellent discharge properties and photocurability, and a photocured product obtained therefrom has a high refractive index and low yellowness.

In addition, the photocured product is suitably used as the microlens and as the liquid-repellent cured film that controls the shape of the microlens.

### DESCRIPTION OF THE EMBODIMENTS

In this specification, “(meth)acrylate” is used for indicating both or either of acrylate and methacrylate. “Refractive index” is a value with respect to light of a wavelength of 589 nm. In addition, an ink that forms a microlens is sometimes called a “lens ink,” and an ink that forms a liquid-repellent cured film capable of controlling a shape of a microlens is sometimes called a “surface treatment agent.”

### 1. Photocurable Inkjet Ink

The photocurable inkjet ink of the invention (hereinafter also “ink of the invention”) contains a compound (A) that has a skeleton structure consisting of at least three benzene rings and at least one group selected from the following organic groups a, wherein all bonds between the benzene rings are formed through one of the groups, and at least one group selected from the following organic groups b that are bonded to the benzene rings.
   [Organic Groups a]

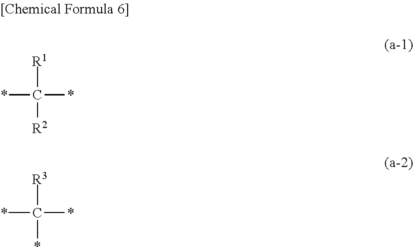

(R¹, R² and R³ are independently hydrogen or an alkyl group having 1 to 5 carbons; and * represents a binding site of the benzene ring.)
   [Organic Groups b]

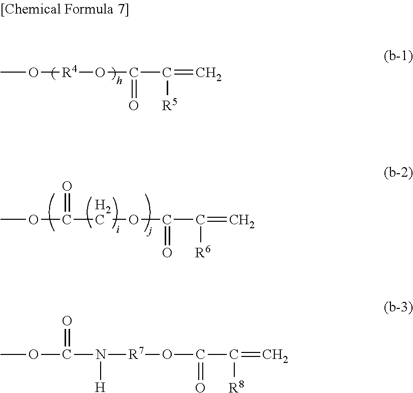

(R⁴ and R⁷ are independently a divalent hydrocarbon group having 1 to 10 carbons; R⁵, R⁶ and R⁸ are independently hydrogen or a methyl group; h is an integer of 0 to 5; and i and j are independently an integer of 1 to 5.)
The inkjet ink of the invention may further contain a compound (B) represented by the following formula (7) or (8), and a photopolymerization initiator (C).

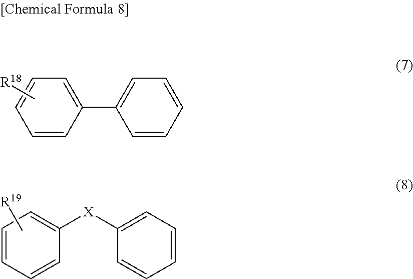

(X is a divalent organic group having 1 to 5 carbons or an oxygen atom; and R¹⁸ and R¹⁹ are selected from the following organic groups c.)
   [Organic Groups c]

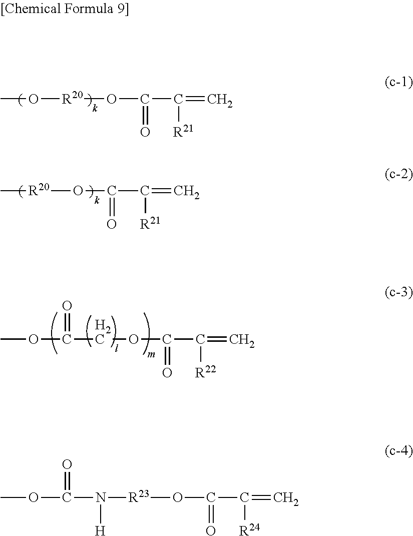

(R²⁰ and R²³ are independently a divalent hydrocarbon group having 1 to 10 carbons; R²¹, R²² and R²⁴ are independently hydrogen or a methyl group; and k, l and m are independently an integer of 1 to 5.)
The ink of the invention may contain a solvent (D), or a (meth)acrylate monomer (E) other than the compounds (A) and (B), for adjusting viscosity. In addition, a surfactant (F) may be contained for adjusting surface tension or for imparting liquid repellency to a cured film. In addition, a radically polymerizable group-containing compound (G), an ultraviolet absorbent, an antioxidant, a polymerization inhibitor and a thermosetting compound, etc. may be contained, if necessary.

The ink of the invention is preferably colorless from the viewpoint of light transmittance. However, it may also be colored as long as the effects of the invention are not impaired. In this case, since it is undesirable that an obtained cured film or the like be yellowish, the ink may be colored, e.g., blue. In addition, the ink of the invention may contain a colorant in order to make it easier to distinguish the cured film or the like from a substrate during inspection of a state of the cured film or the like.

### 1.1 Compound (A)

The compound (A) is a compound that has a skeleton structure consisting of at least three benzene rings and at least one group selected from the following organic groups a, wherein all bonds between the benzene rings are formed through one of the groups, and at least one group selected from the following organic groups b that are bonded to the benzene rings.
   [Organic Groups a]

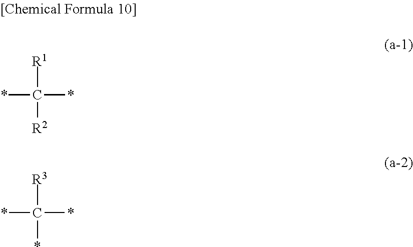

(R¹, R² and R³ are independently hydrogen or an alkyl group having 1 to 5 carbons; and * represents a binding site of the benzene ring.)
   [Organic Groups b]

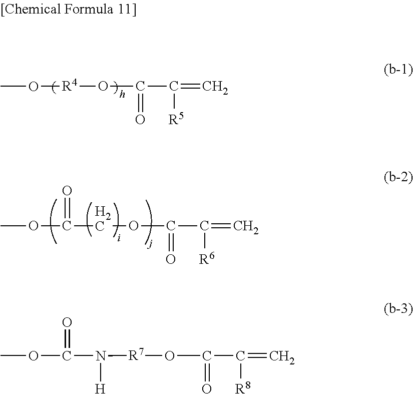

(R⁴ and R⁷ are independently a divalent hydrocarbon group having 1 to 10 carbons; R⁵, R⁶ and R⁸ are independently hydrogen or a methyl group; h is an integer of 0 to 5; and i and j are independently an integer of 1 to 5.)
The skeleton structure consists of at least three benzene rings and at least one group selected from the following organic groups a. That is, the skeleton structure includes no other structural parts than the benzene rings and the group selected from the organic groups a. Moreover, the compound (A) may contain a structural part other than the skeleton structure and the group selected from the following organic groups b. For example, the compound (A) may have a group such as a hydroxyl group and an alkyl bonded to the benzene rings contained in the skeleton structure, etc.

In addition, in the skeleton structure, all bonds between the benzene rings are formed through one of the groups. In other words, all the bonds between each benzene ring and another benzene ring are formed through the group selected from the organic groups a. Accordingly, the skeleton structure does not include a biphenyl bond or the like that is formed by directly bonding benzene rings. In addition, each benzene ring is bonded to another benzene ring through only one of the groups, but not through two or more groups. The compound (A) has a structure obtained by replacing a hydrogen atom bonded to the benzene rings contained in the skeleton structure with the group selected from the organic groups b.

Among such compounds, a compound having a group (b-1) is preferred, and a compound in which the benzene rings are bonded to each other by a propane-2,2-diyl group or an ethane-1,1,1-triyl group is more preferred. Furthermore, the compound (A) is preferably a compound represented by any one of formulae (1) to (3), and is more preferably a compound represented by any one of formulae (4) to (6) since the ink having low viscosity and a cured film having a high refractive index are obtained.

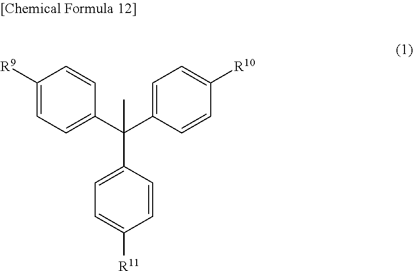

(At least one of R⁹, R¹⁰ and R¹¹ is a group selected from the above organic groups b, and the rest are a hydroxyl group or an alkyl group having 1 to 5 carbons.)

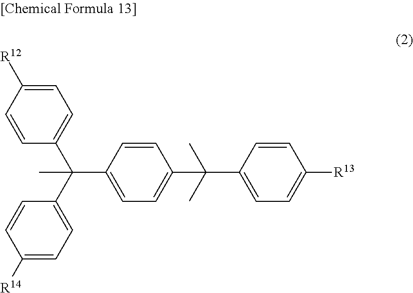

(At least one of R¹², R¹³ and R¹⁴ is a group selected from the above organic groups b, and the rest are a hydroxyl group or an alkyl group having 1 to 5 carbons.)

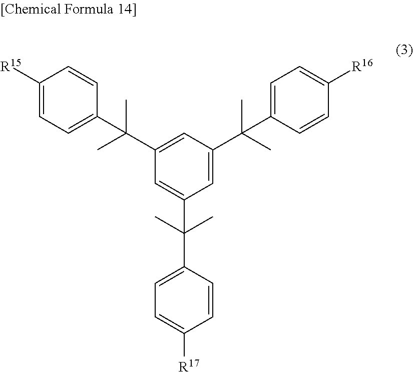

(A compound in which at least one of R¹⁵, R¹⁶ and R¹⁷ is a group selected from the above organic groups b, and the rest are a hydroxyl group or an alkyl group having 1 to 5 carbons.)

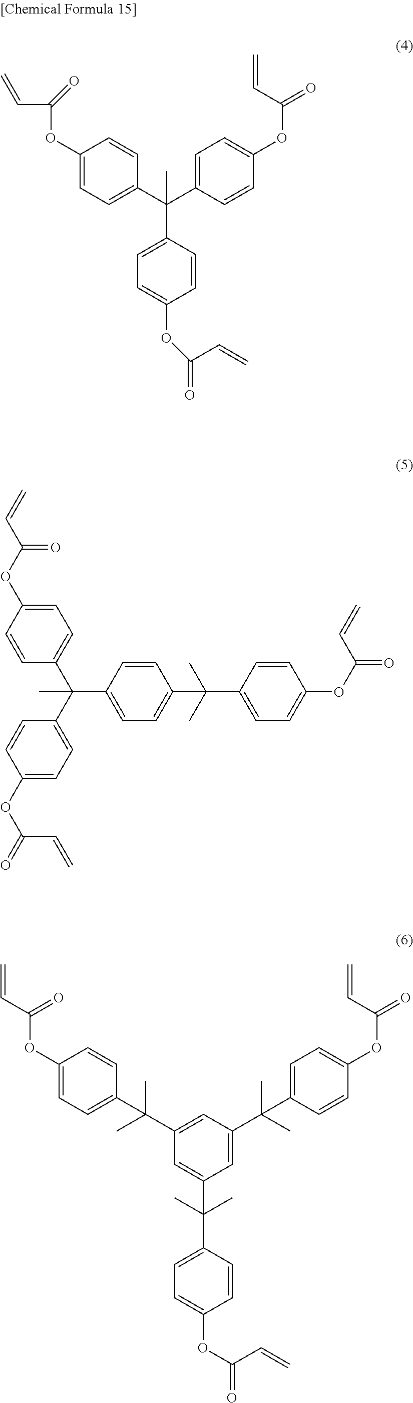 [SMILES: C=CC(=O)Oc1ccc(C(C)(c2ccc(OC(=O)C=C)cc2)c2ccc(OC(=O)C=C)cc2)cc1 ; C=CC(=O)Oc1ccc(C(C)(C)c2ccc(C(C)(c3ccc(OC(=O)C=C)cc3)c3ccc(OC(=O)C=C)cc3)cc2)cc1 ; C=CC(=O)Oc1ccc(C(C)(C)c2cc(C(C)(C)c3ccc(OC(=O)C=C)cc3)cc(C(C)(C)c3ccc(OC(=O)C=C)cc3)c2)cc1]

Such a compound can be synthesized by adding a compound having an acryloyl group to a hydroxyl group of an existing polyhydric phenol.

Examples of the existing polyhydric phenol include TrisP-PA (trade name, made by Honshu Chemical Industry Co., Ltd.), TrisP-HAP (trade name, made by Honshu Chemical Industry Co., Ltd.), TrisP-TC (trade name, made by Honshu Chemical Industry Co., Ltd.), BIP-BZ (trade name, made by Asahi Organic Chemicals Industry Co., Ltd.), BIP-PHBZ (trade name, made by Asahi Organic Chemicals Industry Co., Ltd.), 3PC (trade name, made by Asahi Organic Chemicals Industry Co., Ltd.), TEP-TPA (trade name, made by Asahi Organic Chemicals Industry Co., Ltd.), and Bisphenol-M (trade name, made by Mitsui Fine Chemicals, Inc.).

A method of adding the acryloyl group is not particularly limited, and the acryloyl group can be synthesized by an existing method. Examples thereof include a dehydration esterification method using acrylic acid, a transesterification method of reacting an ester to obtain a new ester, a method using acrylic acid chloride, a method using acrylic acid anhydride and a method of adding an acrylate having an isocyanate group. Among them, the method using acrylic acid chloride that has high reactivity and can be synthesized at low cost is desired.

The compound (A) may be one kind of compound, or may be a mixture of two or more kinds of compounds.

In the inkjet ink of the invention, the content of the compound (A) is preferably 3 to 60 wt %, more preferably 5 to 40 wt %, of a total amount of the ink. When the content of the compound (A) is within the aforementioned range, a cured film having reduced yellowness and a high refractive index is more easily obtained.

### 1.2. Compound (B)

The compound (B) is an acrylate monomer represented by the following formula (7) or (8).

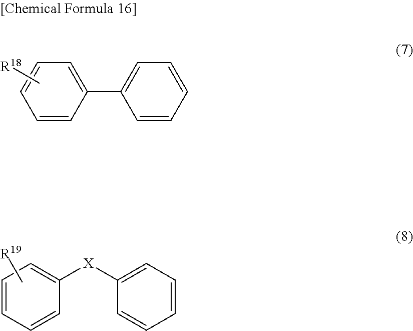

(X is an organic group having 1 to 5 carbons or an oxygen atom; and R¹⁸ and R¹⁹ are groups selected from the following organic groups c.)
   [Organic Groups c]

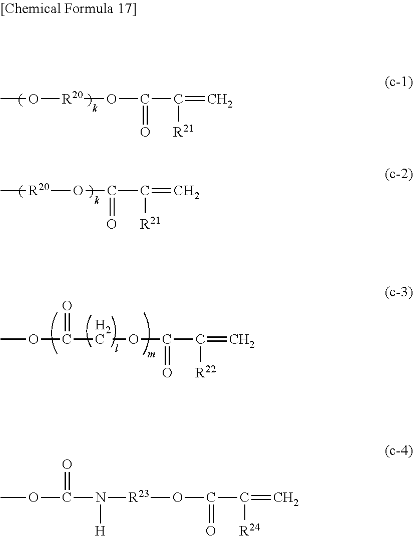

(R²⁰ and R²³ are independently a divalent hydrocarbon group having 1 to 10 carbons; R²¹, R²² and R²⁴ are independently hydrogen or a methyl group; and k, l and m are independently an integer of 1 to 5.)
Specific examples of the compound (B) include m-phenoxybenzyl (meth)acrylate, o-phenylphenol EO-modified (meth)acrylate and paracumylphenol EO-modified (meth)acrylate.

The compound (B) may be one kind of compound, or may be a mixture of two or more kinds of compounds.

In the inkjet ink of the invention, the content of the compound (B) is preferably 1 to 60 wt %, more preferably 5 to 40 wt %, of the total amount of the ink. When the content of the compound (B) is within the aforementioned range, the ink has low viscosity, and it is easy to increase the refractive index of a cured film of the ink.

### 1.3. Photopolymerization Initiator (C)

The photopolymerization initiator (C) is not particularly limited as long as being a compound generating a radical or an acid upon irradiation with an ultraviolet ray or a visible ray. However, an acylphosphine oxide-based initiator, an oxyphenyl acetate-based initiator, a benzoylformic acid-based initiator and a hydroxyphenyl ketone-based initiator are preferred. Among them, from the viewpoint of photocurability of the ink and light transmittance of the obtained cured film or the like, particularly the acylphosphine oxide-based initiator, the oxyphenyl acetate-based initiator and the benzoylformic acid-based initiator are more preferred.

Specific examples of the photopolymerization initiator (C) include benzophenone, Michler's ketone, 4,4′-bis(diethylamino)benzophenone, xanthone, thioxanthone, isopropylxanthone, 2,4-diethylthioxanthone, 2-ethylanthraquinone, acetophenone, 2-hydroxy-2-methyl-4′-isopropylpropiophenone, isopropyl benzoin ether, isobutyl benzoin ether, 2,2-diethoxyacetophenone, 2,2-dimethoxy-2-phenylacetophenone, camphorquinone, benzanthrone, ethyl 4-dimethylaminobenzoate, isoamyl 4-dimethylaminobenzoate, 4,4′-di(t-butylperoxycarbonyl)benzophenone, 3,4,4′-tri(t-butylperoxycarbonyl)benzophenone, 3,3′,4,4′-tetra(t-butylperoxycarbonyl)benzophenone, 3,3′,4,4′-tetra(t-hexylperoxycarbonyl)benzophenone, 3,3′-di(methoxycarbonyl)-4,4′-di(t-butylperoxycarbonyl)benzophenone, 3,4′-di(methoxycarbonyl)-4,3′-di(t-butylperoxycarbonyl)benzophenone, 4,4′-di(methoxycarbonyl)-3,3′-di(t-butylperoxycarbonyl)benzophenone, 2-(4′-methoxystyryl)-4,6-bis(trichloromethyl)-s-triazine, 2-(3′,4′-dimethoxystyryl)-4,6-bis(trichloromethyl)-s-triazine, 2-(2′,4′-dimethoxystyryl)-4,6-bis(trichloromethyl)-s-triazine, 2-(2′-methoxystyryl)-4,6-bis(trichloromethyl)-s-triazine, 2-(4′-pentyloxystyryl)-4,6-bis(trichloromethyl)-s-triazine, 4-[p-N,N-di(ethoxycarbonylmethyl)]-2,6-di(trichloromethyl)-s-triazine, 1,3-bis(trichloromethyl)-5-(2′-chlorophenyl)-s-triazine, 1,3-bis(trichloromethyl)-5-(4′-methoxyphenyl)-s-triazine, 2-(p-dimethylaminostyryl)benzoxazole, 2-(p-dimethylaminostyryl)benzthiazole, 2-mercaptobenzothiazole, 3,3′-carbonylbis(7-diethylaminocoumarin), 2-(o-chlorophenyl)-4,4′,5,5′-tetraphenyl-1,2′-biimidazole, 2,2′-bis(2-chlorophenyl)-4,4′,5,5′-tetrakis(4-ethoxycarbonylphenyl)-1,2′-biimidazole, 2,2′-bis(2,4-dichlorophenyl)-4,4′,5,5 ′-tetraphenyl-1,2′-biimidazole, 2,2′-bis(2,4-dibromophenyl)-4,4′,5,5′-tetraphenyl-1,2′-biimidazole, 2,2′-bis(2,4,6-trichlorophenyl)-4,4′,5,5′-tetraphenyl-1,2′-biimidazole, 3-(2-methyl-2-dimethylaminopropionyl)carbazole, 3,6-bis(2-methyl-2-morpholinopropionyl)-9-n-dodecylcarbazole, bis(η⁵-2,4-cyclopentadiene-1-yl)-bis(2,6-difluoro-3-(1H-pyrrole-1-yl)-phenyl)titanium, 1-hydroxycyclohexyl phenyl ketone, 2-hydroxy-2-methyl-1-phenyl-1-propanone, 1-[4-(2-hydroxyethoxy)-phenyl]-2-hydroxy-2-methyl-1-propanone, 2-hydroxy-1-{4-[4-(2-hydroxy-2-methyl-propionyl)-benzyl]phenyl}-2-methyl-1-propan one, 2-methyl-1-[4-(methylthio)phenyl]-2-morpholino-1-propanone, 2-(dimethylamino)-1-(4-morpholinophenyl)-2-benzyl-1-butanone, 2-(dimethylamino)-2-[(4-methylphenyl)methyl]-1-[4-(4-morpholinyl)phenyl]-1-butanone, oxy-phenyl-acetic acid 2-[2-oxo-2-phenyl-acetoxy-ethoxy]-ethyl ester, oxy-phenyl-acetic acid 2-[2-hydroxy-ethoxy]-ethyl ester, methyl benzoylformate, bis(2,4,6-trimethylbenzoyl)phenylphosphine oxide, 2,4,6-trimethylbenzoyl diphenylphosphine oxide, 2,4,6-trimethylbenzoyldiphenyl phosphinate, 1-[4-(phenylthio)phenyl]-1,2-octanedione 2-(O-benzoyloxime)], and 1-[9-ethyl-6-(2-methylbenzoyl)-9H-carbazole-3-yl]-ethanone-1-(O-acetyloxime).

Among them, 1-hydroxycyclohexyl phenyl ketone, 2-hydroxy-2-methyl-1-phenyl-1-propanone, 1-[4-(2-hydroxyethoxy)-phenyl]-2-hydroxy-2-methyl-1-propanone, 2-hydroxy-1-{4-[4-(2-hydroxy-2-methyl-propionyl)-benzyl]phenyl}-2-methyl-1-propan one, 2,2-dimethoxy-2-phenylacetophenone, oxy-phenyl-acetic acid 2-[2-oxo-2-phenyl-acetoxy-ethoxy]-ethyl ester, oxy-phenyl-acetic acid 2-[2-hydroxy-ethoxy]-ethyl ester, methyl benzoylformate, bis(2,4,6-trimethylbenzoyl)phenylphosphine oxide, 2,4,6-trimethylbenzoyl diphenylphosphine oxide, and 2,4,6-trimethylbenzoyldiphenyl phosphinate are preferred.

As a commercially available photopolymerization initiator (C), Irgacure 184, Irgacure 651, Irgacure 127, Irgacure 1173, Irgacure 500, Irgacure 2959, Irgacure 754, Irgacure MBF, and Irgacure TPO (trade names, made by BASF Japan Ltd.), etc. are preferred.

Among them, Irgacure 754, Irgacure MBF and Irgacure TPO are more preferred since the light transmittance of the obtained cured film or the like is the highest when they are used.

The photopolymerization initiator (C) used in the ink of the invention may be one kind of compound, or may be a mixture of two or more kinds of compounds.

In the inkjet ink of the invention, the content of the photopolymerization initiator (C) is preferably 1 to 15 wt % or more of the total amount of the ink, more preferably 1 to 10 wt % or more of the total amount of the ink in consideration of balance with other materials, and even more preferably 1 to 8 wt % of the total amount of the ink in view of more excellent photocurability with respect to ultraviolet light, and more easily obtaining a cured film having high light transmittance.

### 1.4. Solvent (D)

The ink of the invention may contain the solvent (D) such as an organic solvent or the like for adjusting inkjet discharge properties. When the solvent (D) is used, fine adjustment can be made to viscosity or surface tension of the ink, and the inkjet discharge properties can be adjusted, which is therefore preferred.

The solvent (D) is not particularly limited, and is preferably an organic solvent having a boiling point of 100° C. to 300° C.

Specific examples of the organic solvent having a boiling point of 100 to 300° C. include butyl acetate, isobutyl acetate, butyl propionate, methyl methoxyacetate, ethyl methoxyacetate, butyl methoxyacetate, methyl ethoxyacetate, ethyl ethoxyacetate, methyl 3-methoxypropionate, ethyl 3-methoxypropionate, methyl 3-ethoxypropionate, ethyl 3-ethoxypropionate, methyl pyruvate, ethyl pyruvate, propyl pyruvate, methyl acetoacetate, ethyl acetoacetate, methyl 2-hydroxyisobutyrate, i-propyl 2-hydroxyisobutyrate, methyl lactate, propyl lactate, dioxane, 3-methoxybutanol, 3-methoxybutyl acetate, propylene glycol monomethyl ether, propylene glycol monoethyl ether, propylene glycol monopropyl ether, propylene glycol monobutyl ether, propylene glycol monophenyl ether, ethylene glycol monobutyl ether, ethylene glycol monophenyl ether, diethylene glycol monomethyl ether, diethylene glycol monoethyl ether, diethylene glycol monopropyl ether, diethylene glycol monobutyl ether, diethylene glycol monophenyl ether, dipropylene glycol monomethyl ether, dipropylene glycol monoethyl ether, dipropylene glycol monopropyl ether, dipropylene glycol monobutyl ether, dipropylene glycol monophenyl ether, ethylene glycol, diethylene glycol, propylene glycol, dipropylene glycol, benzyl alcohol, cyclohexanol, 1,4-butanediol, triethylene glycol, tripropylene glycol, tripropylene glycol methyl ether, tripropylene glycol monobutyl ether, propylene glycol monomethyl ether acetate, propylene glycol monoethyl ether acetate, propylene glycol monopropyl ether acetate, dipropylene glycol monomethyl ether acetate, dipropylene glycol monoethyl ether acetate, dipropylene glycol monobutyl ether acetate, ethylene glycol monomethyl ether acetate, ethylene glycol monobutyl ether acetate, cyclohexanone, cyclopentanone, diethylene glycol monomethyl ether acetate, diethylene glycol monoethyl ether acetate, diethylene glycol monobutyl ether acetate, diethylene glycol dimethyl ether, diethylene glycol diethyl ether, diethylene glycol methyl ethyl ether, dipropylene glycol dimethyl ether, toluene, xylene, anisole, γ-butyrolactone, N,N-dimethylacetamide, N-methyl-2-pyrrolidone and dimethyl imidazolidinone.

The solvent (D) used in the ink of the invention may be one kind of compound, or may be a mixture of two or more kinds of compounds.

In the ink of the invention, the content of the solvent (D) is preferably 30 to 85 wt %, more preferably 40 to 80 wt %, and even more preferably 50 to 75 wt %, relative to a total weight of the ink. When the content of the solvent (D) is within the aforementioned range, photocurability is improved.

1.5. (Meth)acrylate Monomer (E) Other than Compounds (A) and (B)
The ink of the invention may contain the (meth)acrylate monomer (E) other than the compounds (A) and (B), for adjusting inkjet discharge properties. When the (meth)acrylate monomer (E) is used, fine adjustment can be made to viscosity or surface tension of the ink, and the inkjet discharge properties can be adjusted.

The (meth)acrylate monomer (E) is not particularly limited, and has viscosity of preferably 0.1 to 70 mPa·s, more preferably 0.1 to 50 mPa·s, at 25° C.

Specific examples of the (meth)acrylate monomer (E) include 2-hydroxyethyl (meth)acrylate, 2-hydroxypropyl (meth)acrylate, 4-hydroxybutyl (meth)acrylate, 1,4-cyclohexanedimethanol mono(meth)acrylate, N-hydroxyethyl (meth)acrylamide, glycidyl (meth)acrylate, 3,4-epoxycyclohexyl (meth)acrylate, methylglycidyl (meth)acrylate, 3-methyl-3-(meth)acryloxymethyloxetane, 3-ethyl-3-(meth)acryloxymethyloxetane, 3-methyl-3-(meth)acryloxyethyloxetane, 3-ethyl-3-(meth)acryloxyethyloxetane, 2-phenyl-3-(meth)acryloxymethyloxetane, 2-trifluoromethyl-3-(meth)acryloxymethyloxetane, 4-trifluoromethyl-2-(meth)acryloxymethyloxetane, (meth)acrylic acid, methyl (meth)acrylate, ethyl (meth)acrylate, isopropyl (meth)acrylate, n-butyl (meth)acrylate, iso-butyl (meth)acrylate, t-butyl (meth)acrylate, cyclohexyl (meth)acrylate, benzyl (meth)acrylate, tricyclo[5.2.1.0^{2,6}]decanyl (meth)acrylate, dicyclopentenyloxyethyl (meth)acrylate, isobornyl (meth)acrylate, phenyl (meth)acrylate, glycerol mono(meth)acrylate, tetrahydrofurfuryl (meth)acrylate, 5-tetrahydrofurfuryloxycarbonylpentyl (meth)acrylate, (meth)acrylate of ethylene-oxide adduct of lauryl alcohol, ω-carboxypolycaprolactone mono(meth)acrylate, mono[2-(meth)acryloyloxyethyl]succinate, mono[2-(meth)acryloyloxyethyl]maleate, mono[2-(meth)acryloyloxyethyl]cyclohexene-3,4-dicarboxylate, (meth)acrylamide, N,N-dimethyl (meth)acrylamide, N,N-diethyl (meth)acrylamide, N,N-dimethylaminopropyl (meth)acrylamide, N-isopropyl (meth)acrylamide, N-(meth)acryloyl morpholine, thioglycidyl (meth)acrylate, phenylthioethyl (meth)acrylate, dicyclopentanyl (meth)acrylate, γ-butyrolactone (meth)acrylate, lauryl (meth)acrylate, methoxyethyl (meth)acrylate, ethoxyethyl (meth)acrylate, methoxybutyl (meth)acrylate, and phenoxyethyl (meth)acrylate.

When the (meth)acrylate monomer (E) is at least one compound selected from the group consisting of cyclohexyl (meth)acrylate, tetrahydrofurfuryl (meth)acrylate, isobornyl (meth)acrylate, dicyclopentanyl (meth)acrylate, tricyclodecanedimethanol di(meth)acrylate, 1,4-cyclohexanedimethanol di(meth)acrylate, γ-butyrolactone (meth)acrylate, n-butyl (meth)acrylate, t-butyl (meth)acrylate, lauryl (meth)acrylate, 2-hydroxyethyl (meth)acrylate, 2-hydroxypropyl (meth)acrylate, 4-hydroxybutyl (meth)acrylate, methoxyethyl (meth)acrylate, ethoxyethyl (meth)acrylate, methoxybutyl (meth)acrylate, benzyl (meth)acrylate, phenoxyethyl (meth)acrylate, and (meth)acrylic acid, viscosity of an obtained composition can be adjusted to enable inkjet discharge, and a cured film or the like having a good balance between a high refractive index and high light transmittance can be fabricated, which is therefore preferred.

The (meth)acrylate monomer (E) may be one kind of compound, or may be a mixture of two or more kinds of compounds.

In the ink of the invention, the content of the (meth)acrylate monomer (E) is preferably 1 to 80 wt %, more preferably 1 to 70 wt %, and even more preferably 1 to 60 wt %, relative to the total weight of the ink. When the content of the (meth)acrylate monomer (E) is within the aforementioned range, the refractive index can be adjusted within a range not impairing the high light transmittance of the cured film obtained from the ink.

### 1.6. Surfactant (F)

When the ink of the invention contains the surfactant (F), surface liquid repellency of the obtained cured film is increased, and a microlens being small and having a controlled pattern size can be formed on the cured film.

Specific examples of the surfactant (F) include Polyflow No. 45, Polyflow KL-245, Polyflow No. 75, Polyflow No. 90, Polyflow No. 95 (trade names, made by Kyoeisha Chemical Co., Ltd.), Disperbyk 161, Disperbyk 162, Disperbyk 163, Disperbyk 164, Disperbyk 166, Disperbyk 170, Disperbyk 180, Disperbyk 181, Disperbyk 182, BYK 300, BYK 306, BYK 310, BYK 320, BYK 330, BYK 342, BYK 344, BYK 346 (trade names, made by BYK Japan KK), KP-341, KP-358, KP-368, KF-96-50CS, KF-50-100CS (trade names, made by Shin-Etsu Chemical Co., Ltd.), Surflon SC-101, Surflon KH-40 (trade names, made by AGC Seimi Chemical Co., Ltd.), Ftergent 222F, Ftergent 251, FTX-218 (trade names, made by Neos Corporation), EFTOP EF-351, EFTOP EF-352, EFTOP EF-601, EFTOP EF-801, EFTOP EF-802 (trade names, made by Mitsubishi Materials Corporation), Megafac F-171, Megafac F-177, Megafac F-475, Megafac R-08, Megafac R-30 (trade names, made by DIC Corporation), fluoroalkyl benzene sulfonate, fluoroalkyl carboxylate, fluoroalkyl polyoxyethylene ether, fluoroalkylammonium iodide, fluoroalkyl betaine, fluoroalkyl sulfonate, diglycerin tetrakis(fluoroalkyl polyoxyethylene ether), fluoroalkyltrimethyl ammonium salt, fluoroalkyl amino sulfonate, polyoxyethylene nonylphenylether, polyoxyethylene octylphenylether, polyoxyethylene laurylether, polyoxyethylene oleylether, polyoxyethylene tridecylether, polyoxyethylene cetylether, polyoxyethylene stearylether, polyoxyethylene laurate, polyoxyethylene olerate, polyoxyethylene stearate, polyoxyethylene laurylamine, sorbitan laurate, sorbitan palmitate, sorbitan stearate, sorbitan oleate, a sorbitan fatty acid ester, polyoxyethylene sorbitan laurate, polyoxyethylene sorbitan palmitate, polyoxyethylene sorbitan stearate, polyoxyethylene sorbitan oleate, polyoxyethylene naphthylether, alkylbenzene sulfonate, and alkyldiphenylether disulfonate.

In addition, when the surfactant (F) is a surfactant having a reactive group, the surfactant hardly bleeds out from the formed cured film or the like, and unevenness in lens diameter of the microlens formed on the cured film is reduced, which is therefore more preferred.

It is preferred that the reactive group be at least one group selected from the group consisting of a (meth)acryloyl group, an oxirane group, and an oxetanyl group, in view of obtaining an ink having high curability.

Specific examples of the surfactant having a (meth)acryloyl group as the reactive group include RS-72K (trade name, made by DIC Corporation), BYK UV 3500, BYK UV 3570 (trade names, made by BYK Japan KK), and TEGO Rad 2200 N, TEGO Rad 2250, TEGO Rad 2300 and TEGO Rad 2500 (trade names, made by Evonik Degussa Japan Co., Ltd.).

In addition, examples of the surfactant having an oxirane group as the reactive group include RS-211K (trade name, made by DIC Corporation), etc.

The surfactant (F) used in the ink of the invention may be one kind of compound, or may be a mixture of two or more kinds of compounds.

In the ink of the invention, the content of the surfactant (F) is preferably 0.1 to 1 wt %, more preferably 0.1 to 0.9 wt %, and even more preferably 0.1 to 0.8 wt %, relative to the total weight of the ink. When the content of the surfactant (F) is within the aforementioned range, the photocurability of the ink and the surface liquid repellency of the obtained cured film are more excellent.

### 1.7. Ultraviolet Absorbent

The ink of the invention may contain an ultraviolet absorbent in order to prevent the obtained cured film or the like from deteriorating due to light such as backlight, etc.

Specific examples of the ultraviolet absorbent include a benzotriazole compound, such as 2-(5-methyl-2-hydroxyphenyl)benzotriazole, 2-(3,5-di-t-butyl-2-hydroxyphenyl)benzotriazole, 2-(3,5-di-t-butyl-2-hydroxyphenyl)-5-chlorobenzotriazole, 2-(3,5-di-t-amyl-2-hydroxyphenyl)benzotriazole, etc.; a triazine compound, such as 2-[4,6-diphenyl-1,3,5-triazin-2-yl]-5-[(hexyl)oxy]phenol, etc.; a benzophenone compound, such as 2-hydroxy-4-n-octyloxybenzophenone, etc.; and an oxalic anilide compound, such as 2-ethoxy-2′-ethyloxalic acid bisanilide, etc.

The ultraviolet absorbent used in the ink of the invention may be one kind of compound, or may be a mixture of two or more kinds of compounds.

### 1.8. Antioxidant

The inkjet ink of the invention may contain an antioxidant in order to prevent oxidation of the obtained cured film or the like.

Specific examples of the antioxidant include a hindered phenolic compound, such as pentaerythritoltetrakis[3-(3,5-di-t-butyl-4-hydroxyphenyl)propionate, triethylene glycol-bis-[3-(3-t-butyl-5-methyl-4-hydroxyphenyl)propionate], 1,6-hexanediol-bis[3-(3,5-di-t-butyl-4-hydroxyphenyl)propionate], octadecyl-3-(3,5-di-t-butyl-4-hydroxyphenyl)propionate, 3,5-di-t-butyl-4-hydroxybenzylphosphonate diethylester, etc.; and an amine compound, such as n-butylamine, triethylamine and diethylaminomethyl methacrylate, etc.

The antioxidant used in the ink of the invention may be one kind of compound, or may be a mixture of two or more kinds of compounds.

### 1.9. Polymerization Inhibitor

The ink of the invention may contain a polymerization inhibitor in order to enhance storage stability. Specific examples of the polymerization inhibitor include 4-methoxyphenol, hydroquinone and phenothiazine. Among them, when phenothiazine is used, an ink is obtained with only a small increase in viscosity even during long-term storage, which is therefore preferred.

The polymerization inhibitor used in the ink of the invention may be one kind of compound, or may be a mixture of two or more kinds of compounds.

### 1.10. Thermosetting Compound

The ink of the invention may contain a thermosetting compound in order to enhance strength of the cured film obtained from the ink within a range not affecting the light transmittance and the refractive index of the cured film, or to enhance adhesiveness of the cured film with the substrate. The thermosetting compound is not particularly limited as long as being a compound having a functional group that can be thermally cured, and examples thereof include an epoxy compound, an epoxy curing agent, a bismaleimide, phenolic resin, phenolic hydroxyl group-containing resin, melamine resin, and a silane coupling agent, etc.

The thermosetting compound may be one kind of compound, or may be a mixture of two or more kinds of compounds.

In the ink of the invention, the content of the thermosetting compound is preferably 1 to 10 wt %, more preferably 1 to 8 wt %, and even more preferably 1 to 6 wt %, relative to the total weight of the ink. When the content of the thermosetting compound is within the aforementioned range, a cured film having higher strength is obtained.

(1) Epoxy Compound
When the ink of the invention contains an epoxy compound, the strength of the cured film or the like obtained from the ink can be enhanced.

The epoxy compound is not particularly limited as long as being a compound having at least one structure represented by the following formula (9-1) or (9-2) in one molecule.

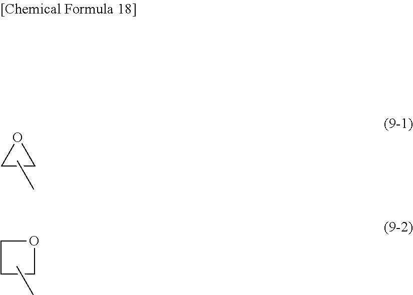

Specific examples of the epoxy compound include an epoxy resin of novolac type (phenol novolac-type and cresol novolac-type), bisphenol A type, bisphenol F type, trisphenolmethane type, hydrogenated bisphenol A-type, hydrogenated bisphenol F-type, bisphenol S type, tetraphenylol ethane-type, bixylenol type and biphenol type, an alicyclic or heterocyclic epoxy resin, as well as an epoxy resin having a dicyclopentadiene skeleton or naphthalene skeleton, wherein novolac type epoxy resin, bisphenol A-type epoxy resin, bisphenol F-type epoxy resin, and trisphenolmethane type epoxy resin are preferred.

The epoxy compound may be an epoxy resin produced by a well-known method, or may be commercially available.

Examples of the commercially available epoxy compound include: a bisphenol A-type epoxy resin, such as jER 828, jER 834, jER 1001, jER 1004 (all being trade names, made by Mitsubishi Chemical Corporation), Epiclon 840, Epiclon 850, Epiclon 1050, Epiclon 2055, (all being trade names, made by DIC Corporation), Epo Tohto YD-011, Epo Tohto YD-013, Epo Tohto YD-127, Epo Tohto YD-128 (all being trade names, made by Nippon Steel Chemical Co., Ltd.), D.E.R. 317, D.E.R. 331, D.E.R. 661, D.E.R. 664 (all being trade names, made by The DOW Chemical Company), Araldite 6071, Araldite 6084, Araldite GY250, Araldite GY260 (all being trade names, made by Huntsman Japan KK), Sumi-Epoxy ESA-011, Sumi-Epoxy ESA-014, Sumi-Epoxy ELA-115, Sumi-Epoxy ELA-128 (all being trade names, made by Sumitomo Chemical Co., Ltd.), A.E.R. 330, A.E.R. 331, A.E.R. 661 and A.E.R. 664 (all being trade names, made by Asahi Kasei E-materials Corporation), etc.;
a novolac type epoxy resin, such as jER 152, jER 154 (both being trade names, made by Mitsubishi Chemical Corporation), D.E.R. 431, D.E.R. 438 (both being trade names, made by The DOW Chemical Company), Epiclon N-730, Epiclon N-770, Epiclon N-865 (all being trade names, made by DIC Corporation), Epo Tohto YDCN-701, Epo Tohto YDCN-704 (both being trade names, made by Nippon Steel Chemical Co., Ltd.), Araldite ECN 1235, Araldite ECN 1273, Araldite ECN 1299 (all being trade names, made by Huntsman Japan KK), XPY307, EPPN-201, EOCN-1025, EOCN-1020, EOCN-104S, RE-306 (all being trade names, made by Nippon Kayaku Co., Ltd.), Sumi-Epoxy ESCN-195X, Sumi-Epoxy ESCN-220 (both being trade names, made by Sumitomo Chemical Co., Ltd.), A.E.R. ECN-235 and A.E.R. ECN-299 (both being trade names, made by Asahi Kasei E-materials Corporation), etc.;
a bisphenol F-type epoxy resin, such as Epiclon 830 (trade name, made by DIC Corporation), jER 807 (trade name, made by Mitsubishi Chemical Corporation), Epo Tohto YDF-170 (trade name, made by Nippon Steel Chemical Co., Ltd.), YDF-175, YDF-2001, YDF-2004 and Araldite XPY306 (all being trade names, made by Huntsman Japan KK), etc.;
a hydrogenated bisphenol A-type epoxy resin, such as Epo Tohto ST-2004, Epo Tohto ST-2007 and Epo Tohto ST-3000 (all being trade names, made by Nippon Steel Chemical Co., Ltd.), etc.;
an alicyclic epoxy resin, such as Celloxide 2021P (trade name, made by Daicel Corporation), Araldite CY175 and Araldite CY179 (both being trade names, made by Huntsman Japan KK), etc.;
a bixylenol type epoxy resin or a biphenol type epoxy resin or a mixture thereof, such as YL-6056, YX-4000 and YL-6121 (all being trade names, made by Mitsubishi Chemical Corporation), etc.;
a bisphenol S-type epoxy resin, such as EBPS-200 (trade name, made by Nippon Kayaku Co., Ltd.), EPX-30 (trade name, made by ADEKA Corporation) and EXA-1514 (trade name, made by DIC Corporation), etc.;
a bisphenol A novolac-type epoxy resin, such as jER 157S (trade name, made by Mitsubishi Chemical Corporation), etc.;
a tetraphenylol ethane-type epoxy resin, such as YL-931 (trade name, made by Mitsubishi Chemical Corporation) and Araldite 163 (trade name, made by Huntsman Japan KK), etc.;
a heterocyclic epoxy resin, such as Araldite PT810 (trade name, made by Huntsman Japan KK) and TEPIC (trade name, made by Nissan Chemical Industries, Limited), etc.;
an epoxy resin having a naphthalene skeleton, such as HP-4032, EXA-4750 and EXA-4700 (all being trade names, made by DIC Corporation), etc.;
an epoxy resin having a dicyclopentadiene skeleton, such as HP-7200, HP-7200H and HP-7200HH (all being trade names, made by DIC Corporation), etc.; and
a trisphenolmethane type epoxy resin, such as Techmore VG3101L (trade name, made by Mitsui Chemicals, Inc.), YL-933 (trade name, made by Mitsubishi Chemical Corporation), EPPN-501 and EPPN-502 (both being trade names, made by Nippon Kayaku Co., Ltd.), etc.

Among them, when jER 828, jER 834, jER 1001, jER 1004 (all being trade names, made by Mitsubishi Chemical Corporation), Techmore VG3101L (trade name, made by Printec Co.), as well as EPPN-501 and EPPN-502 (both being trade names, made by Nippon Kayaku Co., Ltd.) are used, the cured film obtained from the ink has high strength, and these epoxy resins are therefore preferred.

The epoxy resin that can be used in the ink of the invention may be one kind, or may be a mixture of two or more kinds.

(2) Epoxy Curing Agent
When the ink of the invention contains an epoxy curing agent, the strength of the obtained cured film can be further enhanced. The epoxy curing agent is preferably an anhydride-based curing agent and a polyamine-based curing agent, etc.

Examples of the anhydride-based curing agent include maleic anhydride, tetrahydrophthalic anhydride, hexahydrophthalic anhydride, methylhexahydrophthalic anhydride, hexahydrotrimellitic anhydride, phthalic anhydride, trimellitic anhydride and a styrene-maleic anhydride copolymer, etc.

Examples of the polyamine-based curing agent include diethylenetriamine, triethylenetetraamine, tetraethylenepentamine, dicyandiamide, polyamide amine (polyamide resin), a ketimine compound, isophorondiamine, m-xylenediamine, m-phenylenediamine, 1,3-bis(aminomethyl)cyclohexane, N-aminoethylpiperazine, 4,4′-diaminodiphenylmethane, 4,4′-diamino-3,3′-diethyldiphenylmethane, and diaminodiphenyl sulfone, etc.

The epoxy curing agent that can be used in the ink of the invention may be one kind of compound, or may be a mixture of two or more kinds of compounds.

(3) Bismaleimide
When the ink of the invention contains a bismaleimide compound, the strength of the obtained cured film can be further enhanced. The bismaleimide compound is not particularly limited, and is preferably, e.g., a compound represented by the following formula (10). The bismaleimide compound represented by the following formula (10) can be obtained by, e.g., reacting a diamine with an anhydride.

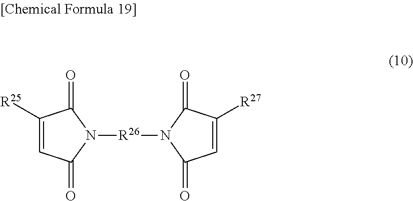

In formula (10), R²⁵ and R²⁷ are each independently hydrogen or methyl, and R²⁶ is a divalent group represented by the following formula (11).

[Chemical Formula 20]

—R²⁸—R²⁹— (11)
In formula (11), R²⁸ and R²⁹ are each independently alkylene having 1 to 18 carbons in which arbitrary non-consecutive (non-adjacent) methylenes are optionally replaced with oxygen, a divalent group having an aromatic ring that may have a substituent, or cycloalkylene that may have a substituent. Examples of the substituent include carboxyl, hydroxy, alkyl having 1 to 5 carbons, and alkoxy having 1 to 5 carbons. In view of obtaining a cured film or the like having high heat resistance, R²⁸ and R²⁹ are each independently preferably one kind of divalent group selected from the following group (12).

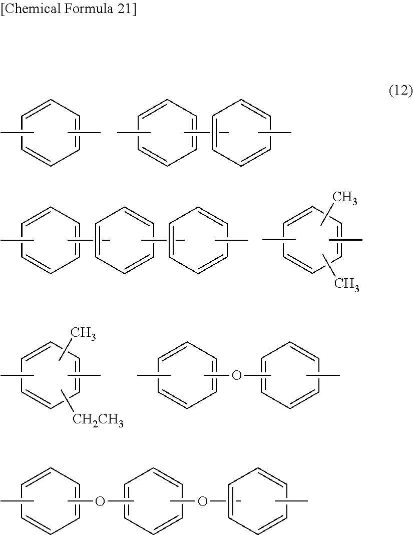

In formula (11), Y is one kind of divalent group selected from the following group (13).

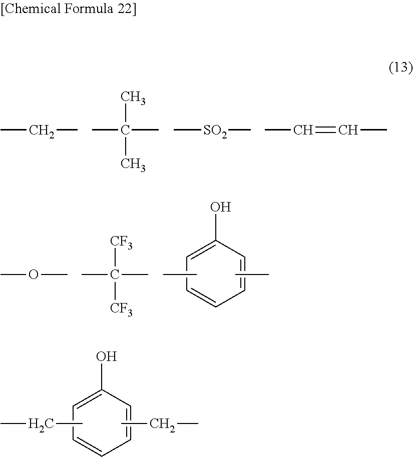

The bismaleimide may be one kind, or may be a mixture of two or more kinds.

(4) Phenolic Resin, or Phenolic Hydroxyl Group-Containing Resin
When the ink of the invention contains phenolic resin or phenolic hydroxyl group-containing resin, the strength of the obtained cured film can be further enhanced. As the phenolic resin, a novolac resin obtained by a condensation reaction of an aromatic compound having a phenolic hydroxyl group with aldehydes is preferably used; as the phenolic hydroxyl group-containing resin, a homopolymer (including a hydrogenated product) of vinylphenol, and a vinylphenol-based copolymer (including a hydrogenated product) of vinylphenol with a compound copolymerizable with the vinylphenol, etc., are preferably used.

Specific examples of the aromatic compound having a phenolic hydroxyl group include phenol, o-cresol, m-cresol, p-cresol, o-ethylphenol, m-ethylphenol, p-ethylphenol, o-butylphenol, m-butylphenol, p-butylphenol, o-xylenol, 2,3-xylenol, 2,4-xylenol, 2,5-xylenol, 3,4-xylenol, 3,5-xylenol, 2,3,5-trimethylphenol, 3,4,5-trimethylphenol, p-phenylphenol, resorcinol, hodroquinone, hydroquinone monomethyl ether, pyrogallol, bisphenol A, bisphenol F, terpene skeleton-containing diphenol, gallic acid, gallate, α-naphthol and β-naphthol.

Specific examples of the aldehydes include formaldehyde, paraformaldehyde, frafural, benzaldehyde, nitrobenzaldehyde and acetaldehyde.

Specific examples of the compound copolymerizable with vinylphenol include (meth)acrylic acid or a derivative thereof, styrene or a derivative thereof, maleic anhydride, vinyl acetate and acrylonitrile.

Specific examples of the phenolic resin include Resitop PSM-6200 (trade name, made by Gunei Chemical Industry Co., Ltd.), Shonol BRG-555 (trade name, made by Showa Denko K.K.); specific examples of the phenolic hydroxyl group-containing resin include Maruka Lyncur M S-2G, Maruka Lyncur CST70 and Maruka Lyncur PHM-C (all being trade names, made by Maruzen Petrochemical Co., Ltd.).

The phenolic resin or the phenolic hydroxyl group-containing resin used in the ink of the invention may be one kind of compound, or may be a mixture of two or more kinds of compounds.

(5) Melamine Resin
When the ink of the invention contains melamine resin, the strength of the obtained cured film can be further enhanced. The melamine resin is not particularly limited as long as being a resin produced by polycondensation of melamine with formaldehyde, and examples thereof include condensates of methylol melamine, etherified methylol melamine, benzoguanamine, methylol benzoguanamine, and etherified methylol benzoguanamine, etc. Among them, in view of improved chemical resistance of the obtained cured film, a condensate of etherified methylol melamine is preferred.

Specific examples of the melamine resin include Nikalac MW-30, MW-30HM, MW-390, MW-100LM and MX-750LM (trade names, made by Sanwa Chemical Co., Ltd.).

The melamine resin that can be used in the ink of the invention may be one kind of compound, or may be a mixture of two or more kinds of compounds.

(6) Silane Coupling Agent
When the ink of the invention contains a silane coupling agent, the adhesiveness of the obtained cured film with the substrate can be enhanced. Specific examples of the silane coupling agent include 3-acryloxypropyltrimethoxysilane, 3-methacryloxypropyltrimethoxysilane, 3-glycidoxypropyltrimethoxysilane, 3-glycidoxypropyltriethoxysilane, 3-aminopropyltrimethoxysilane, and 3-mercaptopropyltrimethoxysilane. Among them, 3-acryloxypropyltrimethoxysilane, 3-methacryloxypropyltrimethoxysilane, 3-glycidoxypropyltrimethoxysilane and 3-glycidoxypropyltriethoxysilane have a polymerizable reactive group and can be copolymerized with other components, and are therefore preferred.

The silane coupling agent that can be used in the ink of the invention may be one kind of compound, or may be a mixture of two or more kinds of compounds.

### 1.11. Thermopolymerization Initiator

The ink of the invention may contain a thermopolymerization initiator in order to enhance curability of the ink through a heating process. Specific examples of the thermopolymerization initiator include 2,2′-azobisisobutyronitrile, 2,2′-azobis(2,4-dimethylvaleronitrile), benzoyl peroxide and di-tert-butyl peroxide. Among them, 2,2′-azobisisobutyronitrile and 2,2′-azobis(2,4-dimethylvaleronitrile) are preferred.

The thermopolymerization initiator that can be used in the ink of the invention may be one kind of compound, or may be a mixture of two or more kinds of compounds.

### 1.12. Viscosity of Ink

The ink of the invention preferably has viscosity of 1.0 to 30 mPa·s as measured at 25° C. using an E-type viscometer. If the viscosity is within this range, when the ink of the invention is coated by an inkjet method, discharge properties by means of an inkjet device are improved. The viscosity of the ink of the invention at 25° C. is more preferably 2.0 to 25 mPa·s, even more preferably 4.0 to 20 mPa·s.

### 1.13. Preparation Method of Ink

The ink of the invention can be prepared by mixing together components as raw materials by a well-known method.

Particularly, the ink of the invention is preferably prepared by mixing the aforementioned component (A) with, if necessary, the component (B), the component (C), the component (D), the component (E), the component (F), the ultraviolet absorbent, the antioxidant, the polymerization inhibitor, the thermosetting compound and the thermopolymerization initiator, etc., and filtering an obtained solution using, e.g., a membrane filter made of ultra-high-molecular-weight polyethylene (UPE) to deaerate the solution. The thus prepared ink has excellent discharge properties when coated by an inkjet method.

### 1.14. Storage of Ink

When stored at 5 to 30° C., the ink of the invention has a small increase in viscosity during storage, and has improved storage stability.

### 1.15. Coating of Ink by Inkjet Method

The ink of the invention can be coated using a well-known inkjet method. Examples of the inkjet method include a piezo method of acting mechanical energy on an ink to discharge the ink from an inkjet head, and a thermal method of acting thermal energy on an ink to discharge the ink.

Examples of the inkjet head include a head having a heating portion formed of a metal and/or a metal oxide, etc. Specific examples of the metal and/or the metal oxide include a metal such as Ta, Zr, Ti, Ni, Al, etc., and a metal oxide thereof.

Examples of a preferred coating device used in coating the ink of the invention include a device that applies energy corresponding to a coating signal to an ink in an inkjet head that has an ink containing portion in which the ink is contained, and that, while generating an ink drop by the energy, performs coating (drawing) corresponding to the coating signal.

The inkjet coating device is not limited to a device having the inkjet head and the ink containing portion separated, and a device having the inkjet head and the ink containing portion inseparably integrated with each other may also be used. In addition, the ink containing portion may be detachably or undetachably integrated with the inkjet head, and may be mounted to a carriage, or may be provided on a fixed part of the device. In the latter case, the ink containing portion may be in a form of supplying the ink to the inkjet head through an ink supply member, e.g., a tube.

The inkjet ink may be heated, and a heating temperature is preferably 80° C. or lower, more preferably 50° C. or lower. The viscosity of the ink of the invention at that heating temperature is preferably 1.0 to 30 mPa·s.

### 1.16. Uses of Ink

The ink of the invention has excellent photocurability and is capable of forming a cured film or the like having a high refractive index and high transparency, and is therefore suitably used for manufacturing a light guide or the like that uses a high refractive index substrate and that is employed in a backlight device, etc.

Specifically, the ink of the invention can be used as an ink for forming a liquid-repellent cured film and as an ink for forming a microlens.

When the ink of the invention is the ink for forming a liquid-repellent cured film, the ink preferably contains a compound (A1) represented by either of the following formulae (15) and (16) and the surfactant (F).

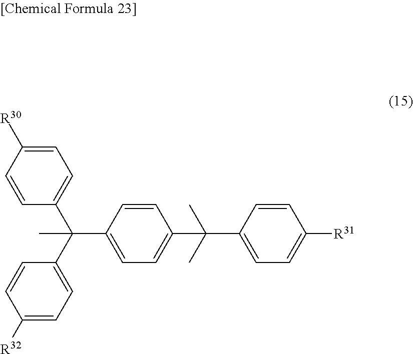

(At least one of R³⁰, R³¹ and R³² is a group selected from the following organic groups d, and the rest are a hydroxyl group or an alkyl group having 1 to 5 carbons.)

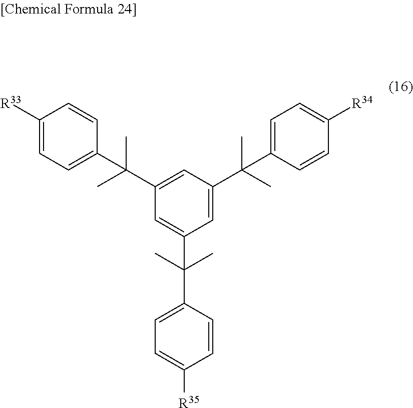

(At least one of R³³, R³⁴ and R³⁵ is a group selected from the following organic groups d, and the rest are a hydroxyl group or an alkyl group having 1 to 5 carbons.)
   [Organic Groups d]

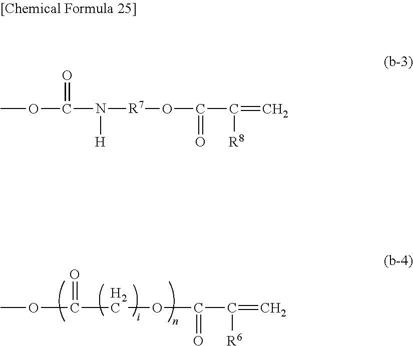

(R⁷ is independently a divalent hydrocarbon group having 1 to 10 carbons; R⁶ and R⁸ are independently hydrogen or a methyl group; i is an integer of 1 to 5; and n is an integer of 0 to 5.)
The compound (A1) is some of the compounds among the compound (A). Moreover, the aforementioned formula (b-4) is a formula obtained by combining formula (b-2) in the organic groups b with formula (b-1) in which h=0.

The content of the compound (A1) is preferably 3 to 60 wt %, more preferably 5 to 40 wt %, and even more preferably 5 to 30 wt %; the content of the surfactant (F) is preferably 0.1 to 1 wt %, more preferably 0.1 to 0.9 wt %, and even more preferably 0.1 to 0.8 wt %. When the contents of the compound (A1) and the surfactant (F) are within the aforementioned ranges, a liquid-repellent cured film having reduced yellowness, a high refractive index and excellent surface liquid repellency is easily obtained.

The compound (A1) is preferably a compound represented by either of the above formulae (5) and (6), more preferably a compound represented by formula (5).

In the case of the ink for forming a liquid-repellent cured film, from the viewpoint of curability, the ink preferably further contains, in addition to the compound (A1) and the surfactant (F), the photopolymerization initiator (C). The photopolymerization initiator (C) is as described above.

In the case of the ink for forming a liquid-repellent cured film, from the viewpoint of reduction in yellowness and inkjet discharge properties, the ink preferably further contains, in addition to the compound (A1) and the surfactant (F), the solvent (D), or a (meth)acrylate monomer (G) other than the compound (A1). The solvent (D) is as described above. Specific examples, content, etc. of the (meth)acrylate monomer (G) are the same as those of the (meth)acrylate monomer (E).

When the ink of the invention is the ink for forming a microlens, the ink preferably contains a compound (A2), and the compound (B) represented by the following formula (7) or (8), wherein the compound (A2) has a skeleton structure consisting of at least three benzene rings and at least one group selected from the following organic groups a, wherein all bonds between the benzene rings are formed through one of the groups, and has at least one group selected from the following organic groups d that are bonded to the benzene rings.

[Organic Groups a]

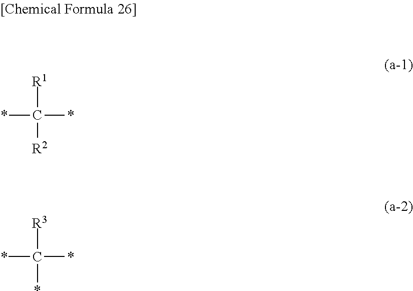

(R¹, R² and R³ are independently hydrogen or an alkyl group having 1 to 5 carbons; and * represents a binding site of the benzene ring.)
   [Organic Groups d]

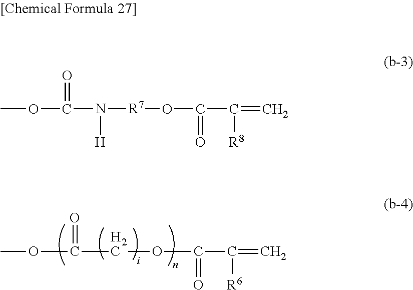

(R⁷ is independently a divalent hydrocarbon group having 1 to 10 carbons; R⁶ and R⁸ are independently hydrogen or a methyl group; i is an integer of 1 to 5; and n is an integer of 0 to 5.)

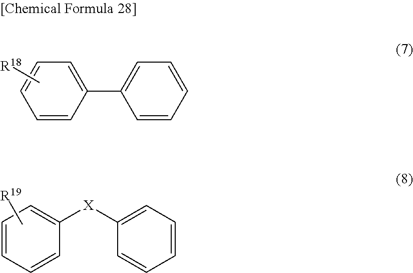

(X is a divalent organic group having 1 to 5 carbons or an oxygen atom; and R¹⁸ and R¹⁹ are groups selected from the following organic groups c.)
   [Organic Groups c]

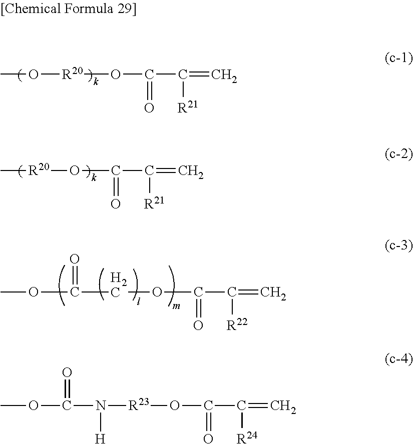

(R²⁰ and R²³ are independently a divalent hydrocarbon group having 1 to 10 carbons; R²¹, R² and R²⁴ are independently hydrogen or a methyl group; and k, l and m are independently an integer of 1 to 5.)
The compound (A2) is some of the compounds among the compound (A).

The content of the compound (A2) is preferably 3 to 60 wt %, more preferably 5 to 40 wt %; the content of the compound (B) is preferably 1 to 60 wt %, more preferably 5 to 40 wt %. When the contents of the compounds (A2) and (B) are within the aforementioned ranges, the ink has low viscosity, reduced yellowness and a high refractive index, and a microlens having a high refractive index is easily obtained.

The compound (A2) is preferably a compound represented by any one of the above formulae (1) to (3), more preferably a compound represented by any one of the above formulae (4) to (6), and even more preferably a compound represented by formula (5).

The compound (B) is preferably m-phenoxybenzyl (meth)acrylate, o-phenylphenol EO-modified (meth)acrylate or paracumylphenol EO-modified (meth)acrylate.

In the case of the ink for forming a microlens, from the viewpoint of curability, the ink preferably further contains, in addition to the compounds (A2) and (B), the photopolymerization initiator (C). The photopolymerization initiator (C) is as described above.

In the case of the ink for forming a microlens, from the viewpoint of reduction in yellowness and inkjet discharge properties, the ink preferably further contains, in addition to the compounds (A2) and (B), the solvent (D), or a (meth)acrylate monomer (H) other than the compounds (A2) and (B). The solvent (D) is as described above. Specific examples, content, etc. of the (meth)acrylate monomer (H) are the same as those of the (meth)acrylate monomer (E).

### 2. Cured Film or the Like

The liquid-repellent cured film and the microlens of the invention are obtained by curing the aforementioned ink of the invention. The liquid-repellent cured film or the microlens obtained by coating the aforementioned ink of the invention by an inkjet method and then irradiating the ink with light such as an ultraviolet ray or a visible ray, etc. to cure the ink is preferred.

When the liquid-repellent cured film and the microlens obtained from the ink of the invention have a thickness of 0.5 μm, the light transmittance at a wavelength of 400 nm is preferably 95% or higher, more preferably 97% or higher.

The refractive index of the liquid-repellent cured film and the microlens obtained from the ink of the invention is preferably 1.55 or more, more preferably 1.55 to 1.65, and even more preferably 1.56 to 1.60.

Moreover, in the invention, the refractive index of the liquid-repellent cured film and the microlens is a value measured using a refractive index measuring device FE-3000 (trade name, made by Otsuka Electronics Co., Ltd.); the light transmittance of the cured film at a wavelength of 400 nm is a value measured using a transmittance measuring device V-670 (trade name, made by JASCO Corporation).

When the ink of the invention is irradiated with an ultraviolet ray or a visible ray, etc., an amount (exposure amount) of light irradiated depends on the composition of the ink of the invention, and is preferably 100 to 5,000 mJ/cm², more preferably 300 to 4,000 mJ/cm², and even more preferably 500 to 3,000 mJ/cm², as measured using an accumulated light meter UIT-201 equipped with an optical receiver UVD-365PD made by Ushio Inc. In addition, a wavelength of the irradiated ultraviolet ray or visible ray, etc. is preferably 200 to 500 nm, more preferably 250 to 450 nm.

Moreover, the exposure amount hereinafter described is a value measured using the accumulated light meter UIT-201 equipped with the optical receiver UVD-365PD made by Ushio Inc.

Moreover, an exposure machine is not particularly limited as long as being a device that is equipped with an electrodeless lamp, a low-pressure mercury lamp, a high-pressure mercury lamp, an ultra-high-pressure mercury lamp, a metal halide lamp, and a halogen lamp, etc. and that irradiates an ultraviolet ray or a visible ray, etc. within a range of 200 to 500 nm.

The lens diameter of the microlens is not particularly limited, and is generally preferably 10 to 100 μm, more preferably 20 to 60 μm. In addition, a lens height is not particularly limited, and is generally preferably 0.5 to 20 μm, more preferably 2 to 15 μm.

### 3. Laminate

The liquid-repellent cured film obtained from the ink of the invention is formed on the substrate, thus constituting a laminate composed of a substrate and a cured film. In addition, the microlens obtained from the ink of the invention is formed on the cured film, thus constituting a laminate composed of a cured film and a microlens, or a laminate composed of a substrate, a cured film and a microlens. Preferably, the microlens obtained from the ink of the invention is formed on the liquid-repellent cured film obtained from the ink of the invention, thus constituting a laminate composed of a substrate, the cured film and the microlens. In addition, the light guide in which the cured film obtained from the ink of the invention is suitably employed is a laminate in which the liquid-repellent cured film obtained from the ink of the invention is formed on a substrate, and in which the microlens obtained from the ink of the invention is formed on the cured film.

### 3.1. Substrate

The substrate is not particularly limited as long as it can serve as an object to be coated with ink, and its shape is not limited to a flat plate shape, and may be a curved shape.

The substrate is not particularly limited, and examples thereof include a polyester-based resin substrate made of polyethylene terephthalate (PET) and polybutylene terephthalate (PBT), etc., a polyolefin-based resin substrate made of polyethylene and polypropylene, etc., a polyvinyl chloride-based resin substrate, a fluorine-based resin substrate, a PMMA substrate, a PC substrate, a PS substrate, an MS substrate, an organic polymer film made of polyamide, polycarbonate and polyimide, etc., a substrate made of cellophane, and a glass substrate.

Among them, particularly the PC substrate, the PS substrate and the MS substrate and the like having a refractive index of 1.55 or more, preferably 1.55 to 1.65, are preferred since a refractive index difference at an interface between the substrate and the liquid-repellent cured film obtained from the ink of the invention is reduced.

The thickness of the substrate is not particularly limited and is generally 10 μm to 10 mm, and is suitably adjusted depending on purposes of use.

### 3.2. Light Guide

The light guide is preferably a laminate in which the liquid-repellent cured film obtained from the ink of the invention is formed on a substrate having a refractive index of 1.55 or more and more preferably 1.55 to 1.65, and in which the microlens obtained from the ink of the invention and having a refractive index of 1.55 or more and more preferably 1.55 to 1.65 is formed on the cured film. When configured in this manner, since the refractive index of the cured film can be set to 1.55 or more, the refractive index difference at the interface between the substrate and the liquid-repellent cured film and at an interface between the liquid-repellent cured film and the microlens can be reduced. Therefore, reflection of light that enters the light guide on each of the interfaces can be suppressed, and the light can be efficiently extracted.

### 4. Optical Component

An optical component of the invention is not particularly limited as long as being formed by a cured product obtained from the ink of the invention. However, in view of extraction efficiency or luminance of light, etc., the optical component is preferably the light guide.

### 5. Image Display Device

An image display device of the invention includes the optical component. Hence, the image display device can be suitably used for an image display device excellent in display characteristics of a liquid crystal display or the like.

### EXAMPLES

The invention is further explained below according to examples, but is not limited thereto.

### Preparation Example 1

### Preparation Example of Acrylate A-1 (Compound Represented by Formula (5))

A 100 mL three-necked flask was equipped with a thermometer and a dropping funnel. 12.74 g (30 mmol) of TrisP-PA (trade name, made by Honshu Chemical Industry Co., Ltd.), 9.21 g (91 mmol) of triethylamine, and 40 ml of THF were placed in the flask and stirred to dissolve. A solution obtained by dissolving 8.24 g (91 mmol) of acrylic acid chloride in 10 ml of THF in an ice bath was dripped therein over 30 minutes using the dropping funnel. After the dripping was completed, the reaction temperature was increased to 50° C. and the resultant was stirred for 3 hours, followed by lowering the temperature to stop the reaction. The reaction solution was cooled to room temperature, and then unreacted acrylic acid chloride was quenched with ice water. After that. The resultant was subjected to separation using a saturated sodium hydrogen carbonate aqueous solution, and acrylic acid being a decomposition product of the acrylic acid chloride was removed. Next, the THF was removed using an evaporator, and 17.01 g of a trifunctional acrylate compound (acrylate A-1) represented by formula (5) was obtained.

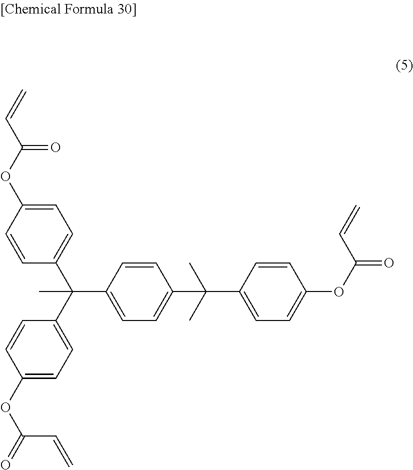 [SMILES: C=CC(=O)Oc1ccc(C(C)(C)c2ccc(C(C)(c3ccc(OC(=O)C=C)cc3)c3ccc(OC(=O)C=C)cc3)cc2)cc1]

### Preparation Example 2

### Preparation Example of Acrylate A-2 (Compound Represented by Formula (6))

A 100 mL three-necked flask was equipped with a thermometer and a dropping funnel. 14.42 g (30 mmol) of TrisP-TC (trade name, made by Honshu Chemical Industry Co., Ltd.), 9.21 g (91 mmol) of triethylamine, and 40 ml of THF were placed in the flask and stirred to dissolve. A solution obtained by dissolving 8.24 g (91 mmol) of acrylic acid chloride in 10 ml of THF in an ice bath was dripped therein over 30 minutes using the dropping funnel. After the dripping was completed, the reaction temperature was increased to 50° C. and the resultant was stirred for 3 hours, followed by lowering the temperature to stop the reaction. The reaction solution was cooled to room temperature, and then unreacted acrylic acid chloride was quenched with ice water. After that. The resultant was subjected to separation using a saturated sodium hydrogen carbonate aqueous solution, and acrylic acid being a decomposition product of the acrylic acid chloride was removed. Next, the THF was removed using an evaporator, and 18.71 g of a trifunctional acrylate compound (acrylate A-2) represented by formula (6) was obtained.

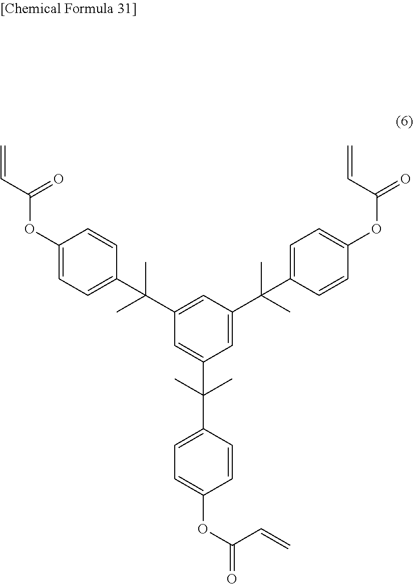 [SMILES: C=CC(=O)Oc1ccc(C(C)(C)c2cc(C(C)(C)c3ccc(OC(=O)C=C)cc3)cc(C(C)(C)c3ccc(OC(=O)C=C)cc3)c2)cc1]

### Preparation Example 3

### Preparation Example of Acrylate A-3 (Compound Represented by Formula (14))

A 100 mL three-necked flask was equipped with a thermometer and a dropping funnel. 12.74 g (30 mmol) of TrisP-PA (trade name, made by Honshu Chemical Industry Co., Ltd.), 40 ml of THF 85.0 mg (135 mmol) of dibutyltin dilaurate, and 12.74 g (30 mmol) of Karenz AOI (trade name, made by Showa Denko K.K., an acrylate having an isocyanate group) were placed in the flask and stirred to dissolve. The reaction temperature was increased to 50° C. and the resultant was stirred for 3 hours, followed by lowering the temperature to stop the reaction. The reaction solution was cooled to room temperature, and was then subjected to separation using a saturated sodium hydrogen carbonate aqueous solution, and the organic layer was extracted. Next, the THF was removed using an evaporator, and 23.51 g of a trifunctional acrylate compound (acrylate A-3) represented by the following structure was obtained.

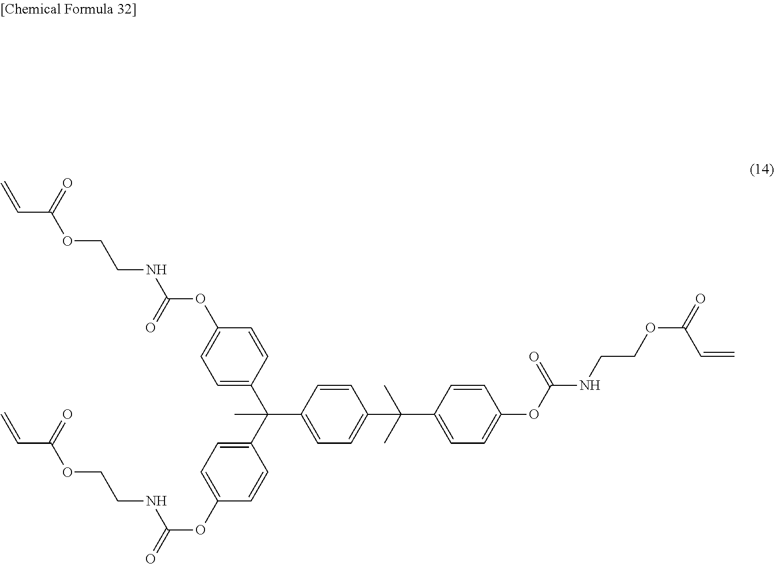 [SMILES: C=CC(=O)OCCNC(=O)Oc1ccc(C(C)(C)c2ccc(C(C)(c3ccc(OC(=O)NCCOC(=O)C=C)cc3)c3ccc(OC(=O)NCCOC(=O)C=C)cc3)cc2)cc1]

### Example 1

### Preparation of Surface Treatment Agent 1

The acrylate A-1 prepared in the above Preparation Example 1 as the compound (A1), TEGO Rad 2200 N (trade name, made by Evonik Degussa Japan Co., Ltd.) having an acryloyl group as the compound (B), Irgacure 754 (trade name, made by BASF, hereinafter abbreviated as “Ir754”) being a mixture of oxy-phenyl-acetic acid 2-[2-oxo-2-phenyl-acetoxy-ethoxy]-ethyl ester and oxy-phenyl-acetic acid 2-[2-hydroxy-ethoxy]-ethyl ester as the photopolymerization initiator (C), methyl 2-hydroxyisobutyrate (made by Mitsubishi Gas Chemical Company, Inc., hereinafter abbreviated as “HBM”) as the organic solvent (D), and Light Acrylate THF-A (trade name, made by Kyoeisha Chemical Co., Ltd., hereinafter abbreviated as “THF-A”) being tetrahydrofurfuryl acrylate as the (meth)acrylate monomer (G) other than the compound (A) were mixed together in the following composition ratios and filtered using a membrane filter (0.2 μm) made of PTFE, and a filtrate (surface treatment agent 1) was obtained.

| | |
|---|---|
| (A1) acrylate A-1 | 10.00 g |
| (C) Ir754 | 2.00 g |
| (D) HBM | 51.80 g |
| (F) TEGO Rad 2200 N | 0.20 g |
| (G) THF-A | 10.00 g |

A result obtained by measuring viscosity of the surface treatment agent 1 at 25° C. using an E-type viscometer was 4.7 mPa·s.

### Example 2

### Preparation of Surface Treatment Agent 2

A surface treatment agent 2 was prepared in the same manner as in Example 1 except that the acrylate A-2 prepared in the above Preparation Example 2 was used as the compound (A1) in place of the acrylate A-1 prepared in the above Preparation Example 1 and that the following composition ratios were adopted.

| | |
|---|---|
| (A1) acrylate A-2 | 10.00 g |
| (C) Ir754 | 2.00 g |
| (D) HBM | 51.80 g |
| (F) TEGO Rad 2200 N | 0.20 g |
| (G) THF-A | 10.00 g |

A result obtained by measuring viscosity of the surface treatment agent 2 at 25° C. using an E-type viscometer was 4.9 mPa·s.

### Example 3

### Preparation of Surface Treatment Agent 3

A surface treatment agent 3 was prepared in the same manner as in Example 1 except that the acrylate A-3 prepared in the above Preparation Example 3 was used as the compound (A1) in place of the acrylate A-1 prepared in the above Preparation Example 1 and that the following composition ratios were adopted.

| | |
|---|---|
| (A1) acrylate A-3 | 10.00 g |
| (C) Ir754 | 2.00 g |
| (D) HBM | 51.80 g |
| (F) TEGO Rad 2200 N | 0.20 g |
| (G) THF-A | 10.00 g |

A result obtained by measuring viscosity of the surface treatment agent 3 at 25° C. using an E-type viscometer was 5.1 mPa·s.

### Example 4

### Preparation of Surface Treatment Agent 4

A surface treatment agent 4 was prepared in the same manner as in Example 1 except that propylene glycol monomethyl ether (made by Tokyo Chemical Industry Co., Ltd., hereinafter abbreviated as “PGME”) was used in place of HBM as the organic solvent (D) and that the following composition ratios were adopted.

| | |
|---|---|
| (A1) acrylate A-1 | 10.00 g |
| (C) Ir754 | 2.00 g |
| (D) PGME | 33.30 g |
| (F) TEGO Rad 2200 N | 0.20 g |
| (G) THF-A | 10.00 g |

A result obtained by measuring viscosity of the surface treatment agent 4 at 25° C. using an E-type viscometer was 4.0 mPa·s.

### Comparative Example 1

### Preparation of Surface Treatment Agent 5

A surface treatment agent 5 was prepared in the same manner as in Example 1 except that EA-0200 was used in place of the acrylate A-1 as the compound (A1) and that the following composition ratios were adopted.

| | |
|---|---|
| EA-0200 | 10.00 g |
| Ir754 | 2.00 g |
| HBM | 51.80 g |
| TEGO Rad 2200 N | 0.20 g |
| THF-A | 10.00 g |

A result obtained by measuring viscosity of the surface treatment agent 5 at 25° C. using an E-type viscometer was 4.9 mPa·s.

### Comparative Example 2

### Preparation of Surface Treatment Agent 6

A surface treatment agent 6 was prepared in the same manner as in Example 2 except that EA-0200 was used in place of the acrylate A-1 as the compound (A1) and that the following composition ratios were adopted.

| | |
|---|---|
| EA-0200 | 10.00 g |
| Ir754 | 2.00 g |
| PGME | 33.30 g |
| TEGO Rad 2200 N | 0.20 g |
| THF-A | 10.00 g |

A result obtained by measuring viscosity of the surface treatment agent 6 at 25° C. using an E-type viscometer was 4.7 mPa·s.

### Comparative Example 3

### Preparation of Surface Treatment Agent 7

A surface treatment agent 7 was prepared in the same manner as in Example 1 except that FRM-1000 was used in place of the acrylate A-1 as the compound (A1) and that the following composition ratios were adopted.

| | |
|---|---|
| FRM-1000 | 10.00 g |
| Ir754 | 2.00 g |
| HBM | 51.80 g |
| TEGO Rad 2200 N | 0.20 g |
| THF-A | 10.00 g |

A result obtained by measuring viscosity of the surface treatment agent 7 at 25° C. using an E-type viscometer was 4.4 mPa·s.

### Comparative Example 4

### Preparation of Surface Treatment Agent 8

A surface treatment agent 8 was prepared in the same manner as in Example 1 except that M-208 was used in place of the acrylate A-1 as the compound (A1) and that the following composition ratios were adopted.

| | |
|---|---|
| M-208 | 10.00 g |
| Ir754 | 2.00 g |
| HBM | 51.80 g |
| TEGO Rad 2200 N | 0.20 g |
| THF-A | 10.00 g |

A result obtained by measuring viscosity of the surface treatment agent 8 at 25° C. using an E-type viscometer was 5.2 mPa·s.

### Comparative Example 5

### Preparation of Surface Treatment Agent 9

A surface treatment agent 9 was prepared in the same manner as in Example 7 except that M-211B was used in place of the acrylate A-1 as the compound (A1) and that the following composition ratios were adopted.

| | |
|---|---|
| M-211B | 10.00 g |
| Ir754 | 2.00 g |
| HBM | 51.80 g |
| TEGO Rad 2200 N | 0.20 g |
| THF-A | 10.00 g |

A result obtained by measuring viscosity of the surface treatment agent 9 at 25° C. using an E-type viscometer was 5.3 mPa·s.

(Evaluation of Inkjet Ink and Photocured Product)
With regard to the surface treatment agents 1 to 9 obtained above, inkjet discharge properties, and with respect to a photocured product thereof, photocurability, refractive index of a cured film, light transmittance of a cured film and yellowness (b*) of a cured film, were evaluated.

The evaluation methods are as follows. The evaluation results are shown in Table 1.

TABLE 1

| | | | | | | | | | Compar- |
|---|---|---|---|---|---|---|---|---|---|
| | | | | | Comparative | Comparative | Comparative | Comparative | ative |
| | Example 1 | Example 2 | Example 3 | Example 4 | Example 1 | Example 2 | Example 3 | Example 4 | Example 5 |
| | Surface | Surface | Surface | Surface | Surface | Surface | Surface | Surface | Surface |
| | treatment | treatment | treatment | treatment | treatment | treatment | treatment | treatment | treatment |
| | agent 1 | agent 2 | agent 3 | agent 4 | agent 5 | agent 6 | agent 7 | agent 8 | agent 9 |
| Inkjet discharge | A | A | A | A | A | A | A | A | A |
| properties | | | | | | | | | |
| (Head temperature | 28 | 28 | 28 | 28 | 28 | 28 | 28 | 28 | 28 |
| [° C.]) | | | | | | | | | |
| Photocurability | A | A | A | A | A | A | A | A | A |
| Refractive index | 1.59 | 1.58 | 1.59 | 1.60 | 1.58 | 1.59 | 1.59 | 1.54 | 1.54 |
| Transmittance | 97.6 | 97.5 | 97.4 | 97.5 | 98.0 | 98.5 | 98.4 | 98.1 | 98.1 |
| [% T] | | | | | | | | | |
| b* | 0.13 | 0.19 | 0.18 | 0.22 | 0.30 | 0.31 | 0.65 | 0.10 | 0.15 |
| Film thickness | 0.7 | 0.5 | 1.2 | 1.4 | 0.7 | 0.7 | 0.5 | 1.1 | 1.1 |
| [μm] of cured film | | | | | | | | | |
| Viscosity [mPa · s] | 4.9 | 5.1 | 4.0 | 6.4 | 4.9 | 4.7 | 4.4 | 5.2 | 5.3 |

### (Inkjet Discharge Method)

The surface treatment agents 1 to 9 obtained in Examples and Comparative Examples were each poured into an inkjet cartridge which was mounted into an inkjet device (DMP-2831 (trade name) of FUJIFILM Dimatix Inc.). Under discharge conditions including a discharge voltage (piezo voltage) of 18 V, a head temperature suitably adjusted according to viscosity of the ink or the composition, a driving frequency of 5 kHz and a number of times of coating being once, a printing resolution was set to 512 dpi, and the surface treatment agents were coated in a pattern of 3 cm square on a central portion of a glass substrate of 4 cm square. The resultant was exposed to UV light of 1000 mJ/cm² using a UV irradiation device (J-CURE1500 (trade name) of Jatec), and whether the film is cured (where no finger marks remain on a pattern surface) was confirmed. The resultant having a film that was not cured with an exposure of 1000 mJ/cm² was further exposed to 1000 mJ/cm² (total exposure amount: 2000 mJ/cm²), and the resultant having a film that was still not cured was further exposed to 1000 mJ/cm² (total exposure amount: 3000 mJ/cm²) and was photocured. In this manner, a glass substrate having a cured film (liquid-repellent cured film) formed thereon was obtained.

The following evaluation of lens and liquid-repellent cured film was carried out by evaluating those exposed with a lowest exposure amount for curing the film (where no finger marks remain on the pattern surface).

Moreover, the thickness was measured using a contact-type thickness meter (P-15 (trade name) of KLA-Tencor Japan).

### (Evaluation of Ink Discharge Properties)

The discharge properties of the inkjet ink (surface treatment agent) were evaluated by observing disorder and blurred printing of the thus obtained cured film pattern of 3 cm square. The evaluation criteria are as follows.
A: A pattern can be formed, and there is no pattern disorder or blurred printing at all.
B: A pattern can be formed, but there is a large amount of pattern disorder and blurred printing.
C: No pattern can be formed (the ink or composition cannot be satisfactorily discharged).

### (Evaluation of Photocurability)

A surface of the cured film of the substrate obtained above that has the cured film pattern of 3 cm square formed thereon was touched with a finger, and the surface state of the cured film pattern was observed through a microscope. The evaluation criteria are as follows.
A: No finger marks remain on the pattern surface at a UV exposure amount of 1000 mJ/cm².
B: Finger marks remain on the pattern surface at a UV exposure amount of 1000 mJ/cm², but do not remain on the pattern surface at a UV exposure amount of 2000 mJ/cm².
C: Finger marks remain on the pattern surface at a UV exposure amount of 2000 mJ/cm², but do not remain on the pattern surface at a UV exposure amount of 3000 mJ/cm².

### (Evaluation of Refractive Index of Cured Film and Light Transmittance of Cured Film)

The refractive index of the cured film pattern, the light transmittance thereof at a wavelength of 400 nm, and the yellowness (b*) thereof were measured using the substrate obtained above that has the cured film pattern of 3 cm square formed thereon.

The refractive index of the cured film pattern was measured using a refractive index measuring device FE-3000 (trade name, made by Otsuka Electronics Co., Ltd.). The light transmittance and the yellowness were measured using a transmittance measuring device V-670 (made by Japan Electronics Co., Ltd.).

The cured film having yellowness (b* value) of 0.30 or more was determined to have high yellowness.

### (Preparation of Lens Ink)

A lens ink for forming a lens on the liquid-repellent cured film was prepared. EA-0200 being an acrylate having a fluorene skeleton, POB-A (trade name, made by Kyoeisha Chemical Co., Ltd.) being m-phenoxybenzyl acrylate, the photopolymerization agent Ir754, and THF-A being tetrahydrofurfuryl acrylate were mixed together in the following composition ratios and filtered using a membrane filter (0.2 μm) made of PTFE, and a filtrate (hereinafter “lens ink A”) was obtained.

| | |
|---|---|
| EA-0200 | 2.00 g |
| POB-A | 1.00 g |
| Ir754 | 0.49 g |
| THF-A | 4.00 g |

A result obtained by measuring viscosity of the lens ink A at 25° C. using an E-type viscometer was 18.2 mPa·s.

### (Formation of Microlens and Evaluation Thereof)

Except that the glass substrate was replaced with a PC substrate, the surface treatment agents 1 to 4 were coated on the substrate and photocured in the same manner under the inkjet discharge conditions shown above. The lens ink A was coated in a dot pattern on the obtained cured film (liquid-repellent cured film) under the same conditions as the coating conditions for the surface treatment agent except that the discharge voltage (piezo voltage) was changed to 20 V and the head temperature was changed to 45° C., so as to form a microlens. A shape of the microlens (dot pattern) obtained as above was observed using an optical microscope BX51 (trade name, made by Olympus Corporation). As a result, in any of the above cured films, the shape of the obtained microlens was substantially a true circle. It is ideal that when the microlens is observed from right above, the lens has a circular shape.

As clear from Table 1 and the evaluation results of the microlens, the inks (the surface treatment agents 1 to 4) obtained in Examples 1 to 4 have excellent inkjet discharge properties and photocurability. In addition, the cured products thereof have a high refractive index, high transparency and reduced yellowness, and moreover enable a microlens having a good shape to be formed thereon. Therefore, the inks are suitably used as photocurable inkjet ink In contrast, the surface treatment agents 5 to 7 have high yellowness after photocuring, and are unsuitable as photocurable inkjet ink. In addition, the surface treatment agents 8 and 9 have low yellowness after photocuring but have a low refractive index, and are unsuitable as photocurable inkjet ink.

The surface treatment agents 1 to 4 obtained in Examples 1 to 4 according to the invention have the optimum characteristics as photocurable inkjet ink, and are therefore industrially effective.

1. A photocurable inkjet ink, containing 3 to 60 wt % of a compound (A1) represented by either of the following formulae (15) and (16) and 0.1 to 1 wt % of a surfactant (F); 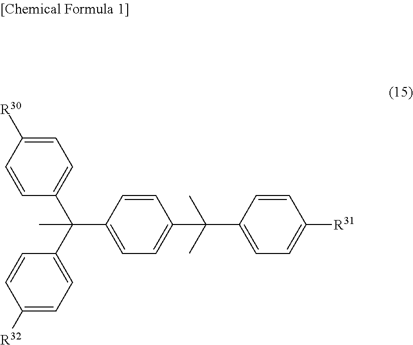
wherein at least one of R³⁰, R³¹ and R³² is a group selected from the following organic groups d, and the rest are a hydroxyl group or an alkyl group having 1 to 5 carbons; 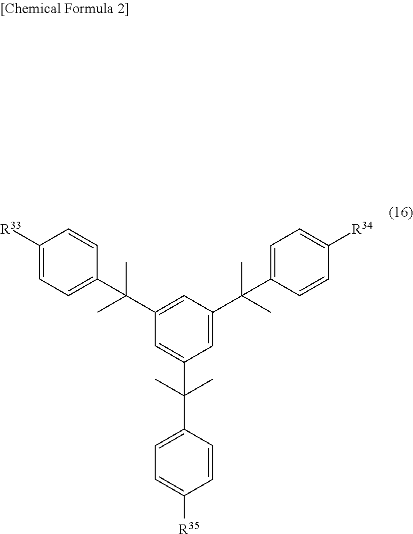
wherein at least one of R³³, R³⁴ and R³⁵ is a group selected from the following organic groups d, and the rest are a hydroxyl group or an alkyl group having 1 to 5 carbons;
[Organic Groups d] 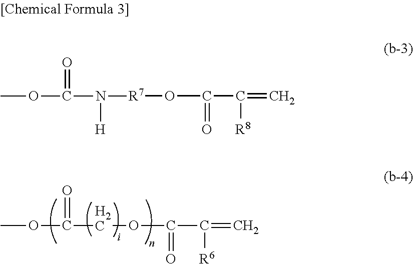
wherein R⁷ is independently a divalent hydrocarbon group having 1 to 10 carbons; R⁶ and R⁸ are independently hydrogen or a methyl group; i is an integer of 1 to 5; and n is an integer of 0 to 5.

2. The photocurable inkjet ink of claim 1, wherein the compound (A1) is a compound represented by either of the following formulae (5) and (6):

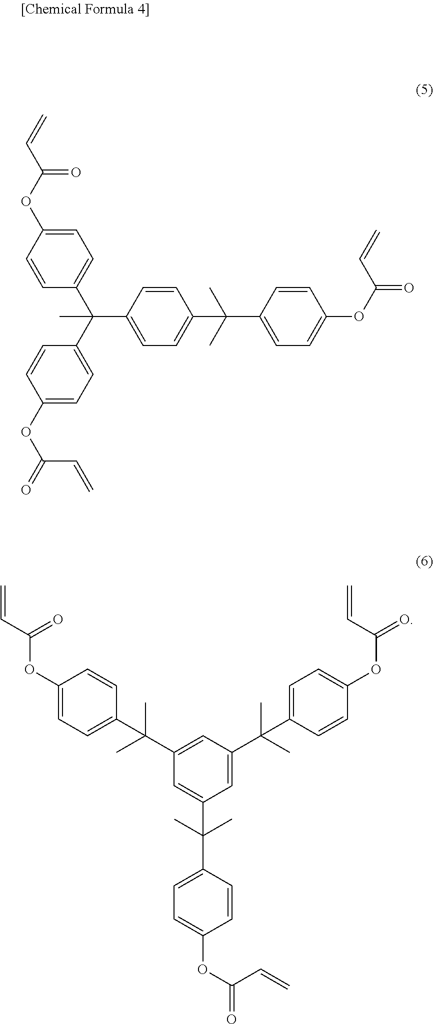 [SMILES: C=CC(=O)Oc1ccc(C(C)(C)c2ccc(C(C)(c3ccc(OC(=O)C=C)cc3)c3ccc(OC(=O)C=C)cc3)cc2)cc1 ; C=CC(=O)Oc1ccc(C(C)(C)c2cc(C(C)(C)c3ccc(OC(=O)C=C)cc3)cc(C(C)(C)c3ccc(OC(=O)C=C)cc3)c2)cc1]

3. The photocurable inkjet ink of claim 1, wherein the compound (A1) is a compound represented by the following formula (5):

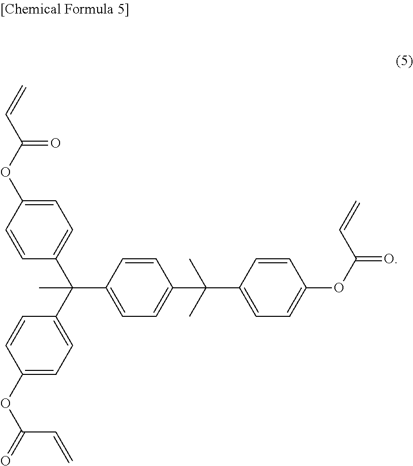 [SMILES: C=CC(=O)Oc1ccc(C(C)(C)c2ccc(C(C)(c3ccc(OC(=O)C=C)cc3)c3ccc(OC(=O)C=C)cc3)cc2)cc1]

4. The photocurable inkjet ink of claim 1, further containing a photopolymerization initiator (C).

5. The photocurable inkjet ink of 4 claim 1, further containing a solvent (D), or a (meth)acrylate monomer (G) other than the compound (A1).

6. A liquid-repellent cured film obtained by photocuring the photocurable inkjet ink of claim 1.

7. A laminate having a substrate that has a refractive index of 1.55 or more with respect to light of a wavelength of 589 nm, and the liquid-repellent cured film of claim 6 formed on the substrate.

8. A laminate having a substrate that has a refractive index of 1.55 or more with respect to light of a wavelength of 589 nm, the liquid-repellent cured film of claim 6 formed on the substrate, and a microlens formed on the liquid-repellent cured film.

9. An optical component having the laminate of claim 8.

10. An image display device comprising the optical component of claim 9.
